(19) United States
(12) Patent Application Publication
(10) Pub. No.: US 2026/0014682 A1
(43) Pub. Date: Jan. 15, 2026

(54) TOOL FOR DRIVING A FASTENER

(71) Applicant: MILWAUKEE ELECTRIC TOOL CORPORATION, Brookfield, WI (US)

(72) Inventors: Jacob J. Wetjen, Brookfield, WI (US); Miguel Arciniega, Mequon, WI (US); Jacob J. Konieczka, Wauwatosa, WI (US); Jacob A. Krabbe, Milwaukee, WI (US); Benjamin D. Bertjens, Cuba City, WI (US)

(21) Appl. No.: 19/268,748

(22) Filed: Jul. 14, 2025

Related U.S. Application Data
(60) Provisional application No. 63/671,581, filed on Jul. 15, 2024.
(60) Provisional application No. 63/746,589, filed on Jan. 17, 2025.

(51) Int. Cl. B25B 23/00; B25B 21/00; B25F 5/00

(52) U.S. Cl. CPC B25B 23/0028; B25B 21/00; B25F 5/001

(57) ABSTRACT

A fastener driving tool is for driving a fastener onto a threaded rod. The fastener driving tool includes a housing, a tower supported by the housing, an input member rotatably supported by the tower, an output member rotatably supported by the tower, and an intermediate member rotatably supported by the tower and operatively coupled between the input member and the output member. The input member defines a first rotational axis. The output member is configured to rotatably support the fastener. The output member defines a second rotational axis. The intermediate member is configured to convert an input torque from the input member about the first rotational axis to an output torque about the second rotational axis.

### CROSS-REFERENCE TO RELATED APPLICATIONS

This application claims priority to U.S. Provisional Patent Application No. 63/671,581, filed on Jul. 15, 2024, and U.S. Provisional Patent Application No. 63/746,589, filed on Jan. 17, 2025, the entire contents of each of which are incorporated herein by reference.

### BACKGROUND

The present invention relates to a fastener driving tool, and more particularly to a fastener driving tool configured to rotate a fastener about a threaded rod.

### SUMMARY

In one embodiment, the invention provides a fastener driving tool for driving a fastener onto a threaded rod. The fastener driving tool includes a housing, a tower supported by the housing, an input member rotatably supported by the tower, an output member rotatably supported by the tower, and an intermediate member rotatably supported by the tower and operatively coupled between the input member and the output member. The input member defines a first rotational axis. The output member is configured to rotatably support the fastener. The output member defines a second rotational axis. The intermediate member is configured to convert an input torque from the input member about the first rotational axis to an output torque about the second rotational axis.

In another embodiment, the invention provides a fastener driving tool for driving a fastener onto a threaded rod. The fastener driving tool includes a housing having a lower housing portion and a tower portion extending from the lower housing portion and a saddle coupled to the tower portion. The saddle and the tower portion define a plurality of retaining portions therebetween. The plurality of retaining portions include a first retaining portion and a second retaining portion. The fastener driving tool also includes an input member rotatably supported by the first retaining portion, an output member rotatably supported by the saddle, and an intermediate member rotatably supported by the second retaining portion and operatively coupled between the input member and the output member. The input member defines a first rotational axis. The output member is configured to rotatably support the fastener. The output member defines a second rotational axis. The intermediate member is configured to convert an input torque from the input member about the first rotational axis to an output torque about the second rotational axis.

In yet another embodiment, the invention provides a fastener driving tool for driving a fastener onto a threaded rod. The fastener driving tool includes a housing, a tower supported by the housing, a first shaft rotatably supported by the tower, a second shaft rotatably supported by the tower, an input member rotatably supported by the first shaft, an output member rotatably supported by the tower, and an intermediate member rotatably supported by the second shaft and operatively coupled between the input member and the output member. The input member defines a first rotational axis. The output member is configured to rotatably support the fastener. The output member defines a second rotational axis. The intermediate member is configured to convert an input torque from the input member about the first rotational axis to an output torque about the second rotational axis.

### BRIEF DESCRIPTION OF THE DRAWINGS

FIG. 1 is a perspective view of a fastener driving tool.

FIG. 2 is a top view of the fastener driving tool of FIG. 1.

FIG. 3 is another perspective view of the fastener driving tool of FIG. 1 with an upper housing removed.

FIG. 4 is an exploded view of the fastener driving tool of FIG. 1.

FIG. 5 is another exploded view of the fastener driving tool of FIG. 1.

FIG. 6 is a cross-sectional view of the fastener driving tool of FIG. 1 taken along line 6-6 in FIG. 2.

FIG. 7 is another cross-sectional view of the fastener driving tool of FIG. 1 taken along line 7-7 in FIG. 2.

FIG. 8 is a perspective view of a bushing for use with the fastener driving tool of FIG. 1.

FIG. 9 is another perspective view of the bushing of FIG. 8.

FIG. 10 is a perspective view of a lower housing and a tower of the fastener driving tool of FIG. 1.

FIG. 11 is a perspective view of the upper housing of the fastener driving tool of FIG. 1.

FIG. 12 is a perspective view of an output gear of the fastener driving tool of FIG. 1.

FIG. 13 is a cross-sectional view of the fastener driving tool of FIG. 1 taken along line 7-7 in FIG. 2, the fastener driving tool including a bearing coupled to an intermediate bevel gear.

FIG. 14 is an enlarged view of the bearing coupled to the intermediate bevel gear taken at callout 14-14 of FIG. 13.

FIG. 15 is a perspective view of the intermediate bevel gear of FIG. 13.

FIG. 16A is an exploded view of the fastener driving tool of FIG. 1, the fastener driving tool including a tower having a shaft extending through a bearing and an intermediate bevel gear.

FIG. 16B is a cross-sectional view of the fastener driving tool of FIG. 16A.

FIG. 17 is an exploded view of another fastener driving tool.

FIG. 18 is another exploded view of the fastener driving tool of FIG. 17.

FIG. 19 is a perspective view of a lower housing and a saddle of the fastener driving tool of FIG. 17.

FIG. 20 is a perspective view of another fastener driving tool.

FIG. 21 is a perspective view of the fastener driving tool of FIG. 20 with an upper housing removed.

FIG. 22 is a cross-sectional view of the fastener driving tool of FIG. 20 taken along line 22-22.

FIG. 23 is a perspective view of another fastener driving tool.

FIG. 24 is a top view of the fastener driving tool of FIG. 23.

FIG. 25 is another perspective view of the fastener driving tool of FIG. 23 with an upper housing removed.

FIG. 26 is an exploded view of the fastener driving tool of FIG. 23.

FIG. 27 is another exploded view of the fastener driving tool of FIG. 23.

FIG. 28 is a cross-sectional view of the fastener driving tool of FIG. 23 taken along line 28-28 in FIG. 24.

FIG. 29 is an enlarged view of a first bevel gear of the fastener driving tool, taken at callout 29-29 in FIG. 28.

FIG. 30 is another cross-sectional view of the fastener driving tool of FIG. 23 taken along line 30-30 in FIG. 24.

FIG. 31 is an enlarged view of an intermediate bevel gear of the fastener driving tool, taken at callout 31-31 in FIG. 30.

FIG. 32 is a perspective view of a lower housing and a tower of the fastener driving tool of FIG. 23.

FIG. 33 is a perspective view of the upper housing of the fastener driving tool of FIG. 23.

FIG. 34 is a perspective view of the intermediate bevel gear of the fastener driving tool of FIG. 31.

FIG. 35 is a perspective view of the first bevel gear of the fastener driving tool of FIG. 29.

FIG. 36 is a perspective view of an upper housing portion for use with a fastener driving tool.

FIG. 37 is a bottom view of the upper housing portion of FIG. 36.

FIG. 38 is an exploded view of the upper housing of FIG. 36 and a second bevel gear.

FIG. 39 is a perspective view of the fastener driving tool of FIG. 1 with the upper housing removed and a including a first support bracket.

FIG. 40 is a perspective view of the first support bracket of FIG. 39.

FIG. 41 is a perspective view of the fastener driving tool of FIG. 1 with the upper housing removed and including a second support bracket.

FIG. 42 is a perspective view of the second support bracket of FIG. 41.

FIG. 43 is a perspective view of a transmission assembly for use in a fastener driving tool.

FIG. 44 is a side view of the transmission assembly of FIG. 43.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

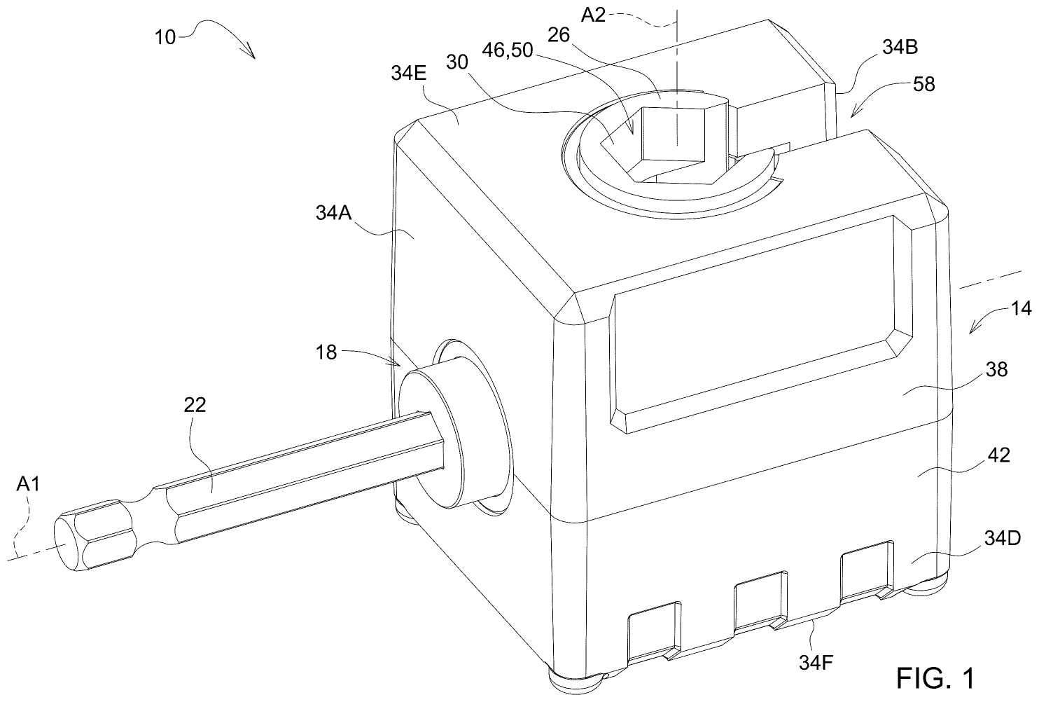

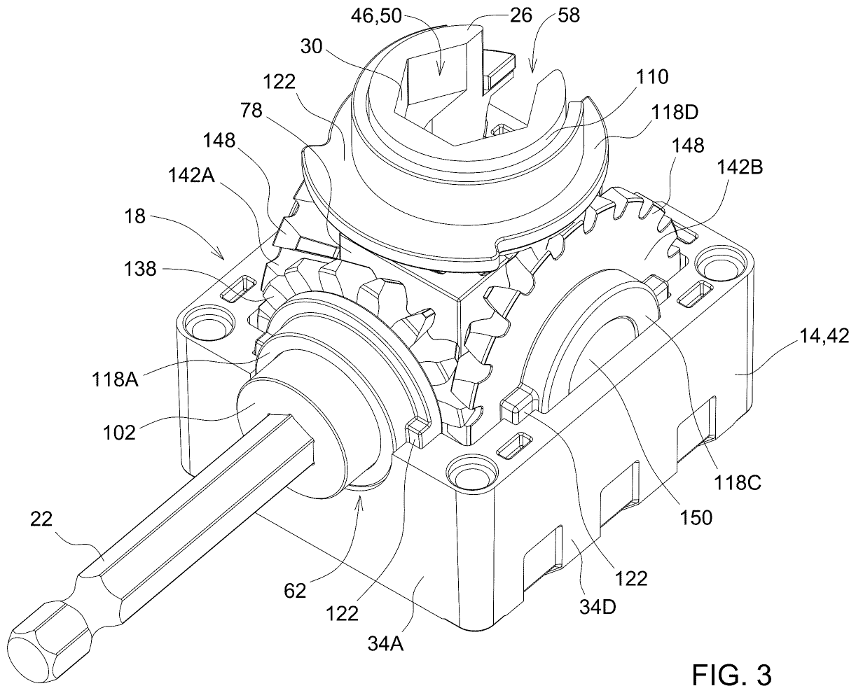

FIGS. 1-3 illustrate a fastener driving tool 10. The fastener driving tool 10 includes a housing 14, a transmission assembly 18, an input shaft 22, and an output member 26. The transmission assembly 18 and the output member 26 are supported at least partially within the housing 14. The transmission assembly 18 is operatively coupled between the input shaft 22 and the output member 26. The input shaft 22 is selectively coupled to a power tool, such as a drill. The input shaft 22 is driven to rotate about a first rotational axis A1 by a torque applied by the power tool. The input shaft 22 defines the first rotational axis A1. The transmission assembly 18 converts input torque about the first rotational axis A1 to an output torque acting on the output member 26. The output torque drives the output member 26 to rotate along a second rotational axis A2. In illustrated embodiments, the second rotational axis A2 is perpendicular to the first rotational axis A1. In other embodiments, the second rotational axis A2 may be oblique relative to the first rotational axis A1. The output member 26 includes a drive socket 30 configured to receive a fastener (e.g., a hex nut) for driving of the fastener by the driving tool 10.

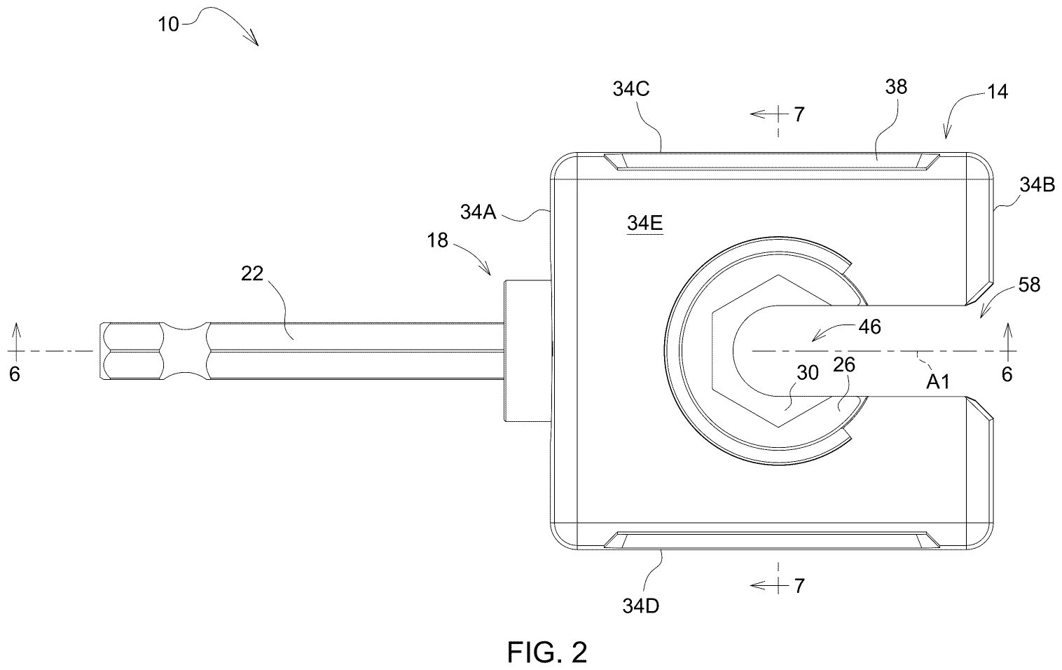

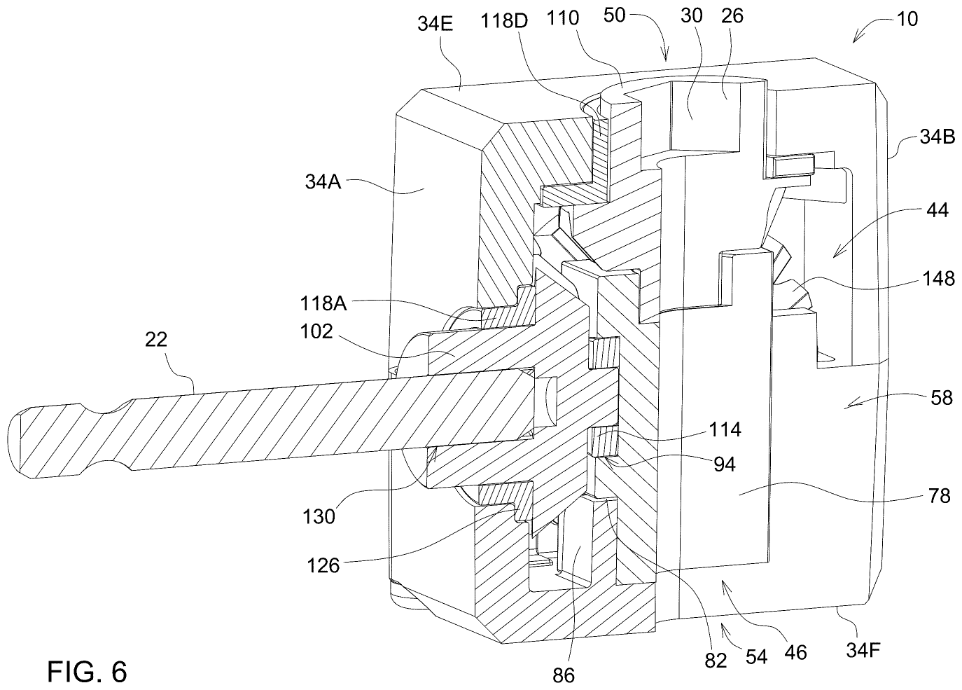

With reference to FIGS. 1 and 2, the housing 14 defines a plurality of sides 34A-34F (also referred to as a plurality of walls 34A-34F). The illustrated housing 14 includes a first side 34A (also referred to as a front side 34A), a second side 34B (also referred to as a rear side 34B) opposite the front side 34A, and third and fourth sides 34C, 34D extending between the front and rear sides 34A, 34B. The housing 14 also includes fifth and sixth sides 34E, 34F (also referred to as top and bottom sides 34E, 34F) extending between the front and rear sides 34A, 34B, and the third and fourth sides 34C, 34D to form a cuboid or box-like shape. In the illustrated embodiment, the housing 14 includes a first housing portion 38 (also referred to an upper housing portion 38) and a second housing portion 42 (also referred to as a lower housing portion 42) coupled to the upper housing portion 38. In other embodiments, the housing 14 can include any suitable number of housing portions (e.g., one, three, etc.) to support the transmission assembly 18 and the output member 26. The housing 14 may be made of a relatively lightweight material, such as plastic or aluminum. The housing 14 defines an internal cavity 44 (shown in FIG. 6). The cavity 44 receives the transmission assembly 18 and the output member 26 therein.

With continued reference to FIGS. 1 and 2, the fastener driving tool 10 includes a channel 46 extending through the housing 14. The illustrated channel 46 includes a first end 50 extending through the top side 34E of the housing 14 and a second end 54 (shown in FIG. 6) extending through the bottom side 34F. The output member 26 partially defines the channel 46 proximate the first end 50. The channel 46 defines the second rotational axis A2. The channel 46 is connected with an opening 58 extending through the housing 14. The illustrated opening 58 extends through the rear side 34B, the top side 34E, and the bottom side 34F. During operation, a threaded rod is moved through the opening 58 and then into the channel 46, which is described in further detail below.

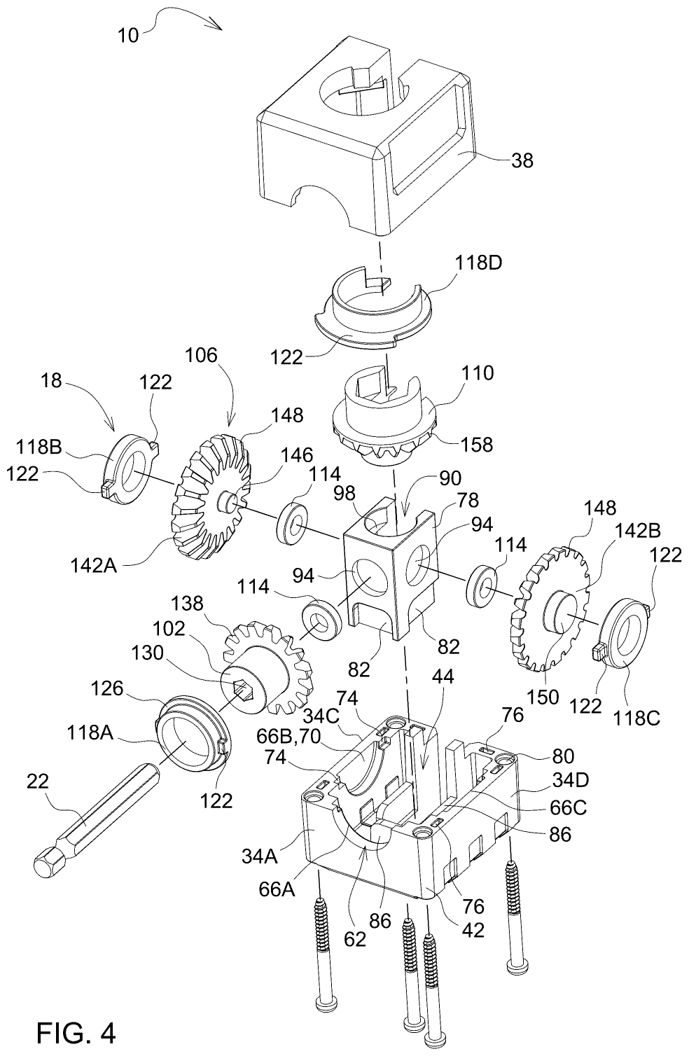

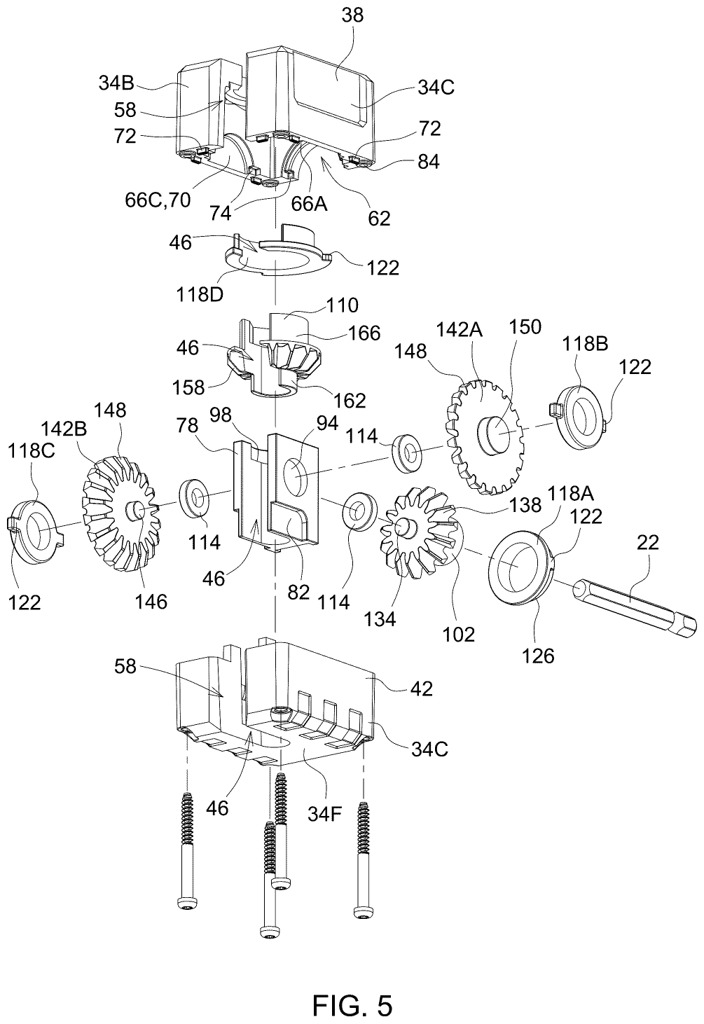

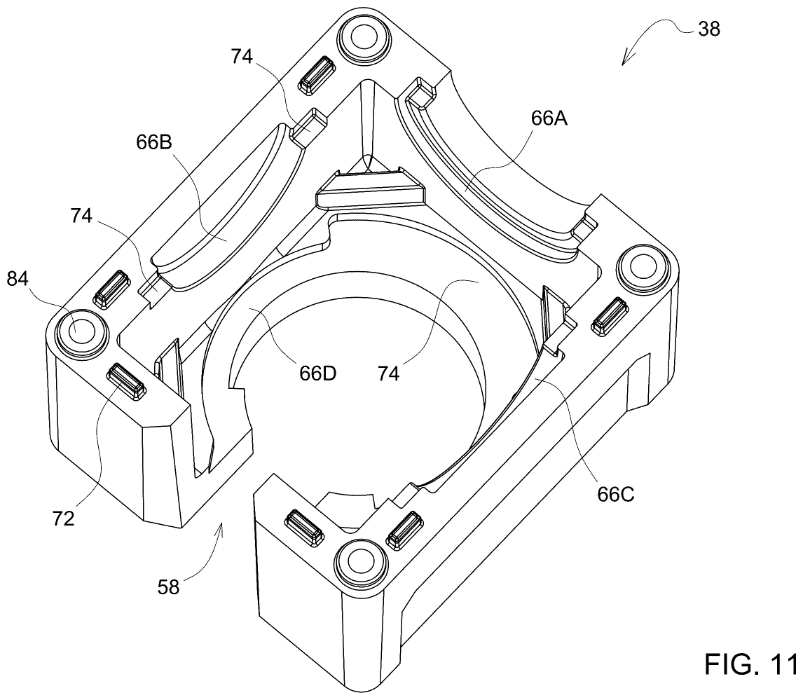

With reference to FIGS. 4 and 5, the housing 14 includes an aperture 62 extending through the front side 34A of the housing 14. The aperture 62 is connected with the cavity 44. The illustrated aperture 62 is defined by the upper and lower housing portions 38, 42. The input shaft 22 extends through the aperture 62 into the cavity 44. The housing 14 further includes a plurality of housing notches 66A-66D within the cavity 44. The first housing notch 66A is defined by an inner surface of the front side 34A. The first housing notch 66A is aligned with the aperture 62. As such, the aperture 62 extends through a central portion of the housing notch 66A. The second and third housing notches 66B, 66C are defined by inner surfaces of the third and fourth sides 34C, 34D, respectively. Each of the housing notches 66A-66C includes a central portion 70 and radial cutouts 74 extending from the central portion 70. In the illustrated embodiment, each of the housing notches 66A-66C includes two radial cutouts 74 extending from opposite sides of the central portion 70. In other embodiments, the housing notches 66A-66C can include any suitable number of radial cutouts 74 extending from any suitable part of the central portion 70. The fourth housing notch 66D is defined by an inner surface of the top side 34E (shown in FIG. 11). The fourth housing notch 66D includes one radial cutout 74.

Each of the housing notches 66A-66C on the first, third, and fourth sides 34A, 34C, 34D are defined by both the upper housing portion 38 and the lower housing portion 42. In other words, a portion of the housing notch 66A-66C on each of the first, third, and fourth sides 34A, 34C, 34D is defined by the upper housing portion 38, and another portion of the respective housing notch 66A-66C is defined by the lower housing portion 42.

With continued reference to FIGS. 4 and 5, the upper housing portion 38 includes a plurality of projections 72. Each projection 72 is received in a respective recess 76 in the lower housing portion 42. The projections and recesses 72, 76 assist with aligning the upper and lower housing portions 38, 42 during assembly. The projections and recesses 72, 76 also help couple the upper and lower housing portions 38, 42 together. In the illustrated embodiment, the upper housing portion 38 includes six projections 72, and the lower housing portion 42 includes six recesses 76. In other embodiments, the housing 14 can include any suitable number of mating projections and recesses 72, 76 (e.g., four, five, etc.). In other embodiments, the lower housing portion 42 can include projections and the upper housing portion 38 can include recesses. In the illustrated embodiment, the lower housing portion 42 also includes bores 80. Each bore 80 receives a boss 84 in the upper housing portion 38 to further couple the upper and lower housing portions 38, 42 together. In the illustrated embodiment, the upper housing portion 38 includes four bosses 84, and the lower housing portion 42 includes four bores 80. In other embodiments, the housing 14 can include any suitable number of mating bores and bosses 80, 84 (e.g., three, five, etc.). In other embodiments, the lower housing portion 42 can include bosses and the upper housing portion 38 can include bores.

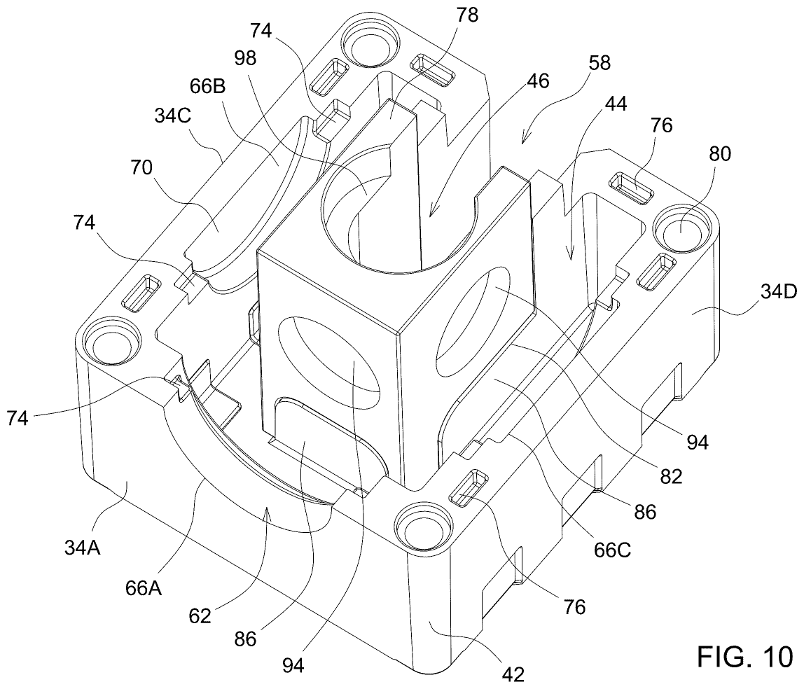

With continued reference to FIGS. 4 and 5, the fastener driving tool 10 includes a tower 78 positioned in the cavity 44. The tower 78 supports the transmission assembly 18. The illustrated tower 78 is coupled to the housing 14. The tower 78 includes tower notches 82 on a lower side of the tower 78. Each tower notch 82 receives a similarly shaped connection flange 86 extending from the housing 14. In the illustrated embodiment, each tower notch 82 and connection flange 86 includes rounded corners to improve the connection between the housing 14 and the tower 78 (shown in FIG. 10). In other embodiments, each tower notch 82 and connection flange 86 can include differently shaped corners (e.g., chamfered, square, etc.). In the illustrated embodiment, the tower 78 includes one tower notch 82 on three sides, each of which are engaged by one respective connection flange 86. The tower 78 also includes a tower channel 90, which extends through the tower 78. The tower channel 90 further defines the channel 46. The tower 78 further includes bushing retainers 94. The bushing retainers 94 assist in securing the transmission assembly 18 to the tower 78. The illustrated tower 78 includes three bushing retainers 94. Each bushing retainer 94 is positioned above one tower notch 82. The tower 78 also includes a tower seat 98. The tower seat 98 is on a top side of the tower 78 and surrounds the tower channel 90. The tower seat 98 assists in securing the transmission assembly 18 to the tower 78. The tower 78 is composed of a rigid material to improve the strength of the fastener driving tool 10. In particular, the tower 78 may be composed of a stronger and/or harder material than the housing 14. For example, the tower 78 can be composed of a metal (e.g., aluminum, steel, etc.) or any suitable material to improve the strength of the fastener driving tool 10.

With reference to FIGS. 4-7, the transmission assembly 18 includes a plurality of gears. In the illustrated embodiment, the transmission assembly 18 includes a first bevel gear 102 (also referred to as an input member 102), an intermediate bevel gear assembly 106, and a second bevel gear 110 (also referred to as an output member 110). In other embodiments, the transmission assembly 18 may include fewer or more gears. The transmission assembly 18 also includes a plurality of inner bushings 114 for rotatably supporting the first bevel gear 102, the intermediate bevel gear assembly 106, and the second bevel gear 110 by the tower 78, and a plurality of outer bushings 118A-118D for rotatably supporting the first bevel gear 102, the intermediate bevel gear assembly 106, and the second bevel gear 110 by the housing 14. Each inner bushing 114 is received in one respective bushing retainer 94 in the tower 78. The inner bushings 114 can be, for example, O-rings.

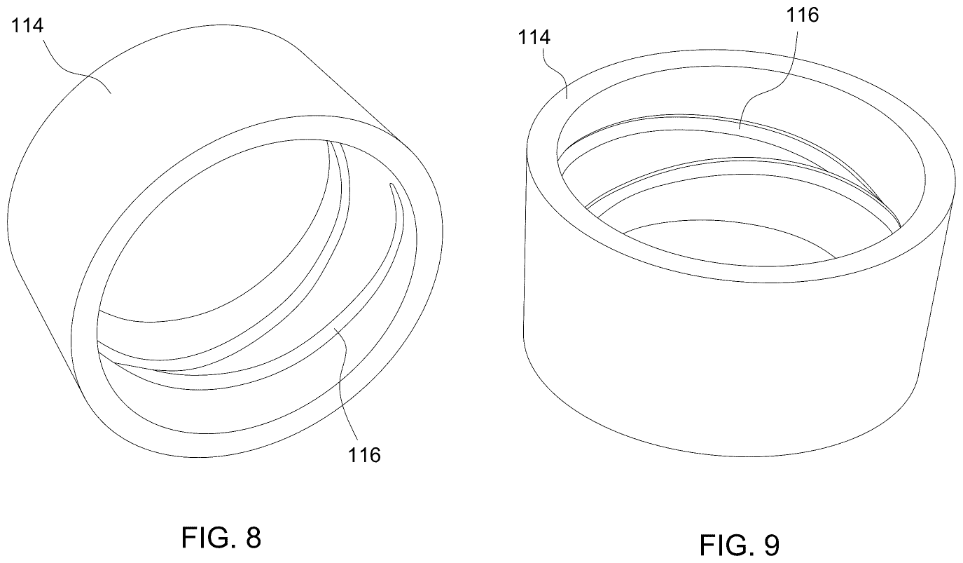

With reference to FIGS. 8 and 9, each inner bushing 114 can include a groove 116. The groove 116 can improve the flow of a lubricant such as oil along the inner bushing 114. The illustrated groove 116 extends along an inner surface of the inner bushing 114. More specifically, the illustrated groove 116 extends more than one revolution around the inner surface of the inner bushing 114. In other embodiments, the groove 116 can extend any suitable number of revolutions around the inner surface (e.g., two, three, etc.) and in any suitable orientation (e.g., helical, axial, etc.) to improve the flow of the lubricant along the inner bushing 114. In other embodiments, each inner bushing 114 can include grooves 116 extending along the edges and/or the outer surface in addition to or in replacement of the grooves 116 extending along the inner surface.

The outer bushings 118A-118D are received in the housing notches 66A-66D, respectively. Each outer bushing 118A-118C includes a pair of radial lugs 122. Each radial lug 122 is received in one respective radial cutout 74. The radial lugs 122 inhibit the outer bushings 118-118C from rotating with the first bevel gear 102, or the intermediate bevel gear assembly 106, and the second bevel gear 110. In other embodiments, each outer bushing 118A-118C can include any number of radial lugs 122 that each engage a respective radial cutout. The outer bushing 118D includes a single radial lug 122, which is received in the radial cutout 74 in the fourth housing notch 66D. The radial lug 122 in the outer bushing 118D inhibits the outer bushing 118D from rotating with the second bevel gear 110. The outer bushing 118A also includes an annular flange 126. The annular flange 126 engages an inner surface of the front side 34A to seal the aperture 62.

The first bevel gear 102 is coupled for co-rotation with the input shaft 22 about the first rotational axis A1. In the illustrated embodiment, the first bevel gear 102 includes a bore 130, which is shaped similarly to the input shaft 22 (e.g., hexagonally). The input shaft 22 is selectively insertable into the bore 130 to couple the input shaft 22 to the first bevel gear 102. In other embodiments, the input shaft 22 can be permanently coupled to the first bevel gear 102 by, for example, welding, adhesives, fasteners, etc. The first bevel gear 102 also includes a first projection 134 on a side of the first bevel gear 102 opposite the bore 130. The first projection 134 extends through one inner bushing 114 and into the respective bushing retainer 94. The first bevel gear 102 is rotatable relative to the inner bushing 114. The groove 116 can improve flow of the lubricant between the first projection 134 and the inner bushing 114 to decrease friction as the bevel gear 102 rotates relative to the inner bushing 114. The first bevel gear 102 also includes a plurality of first teeth 138.

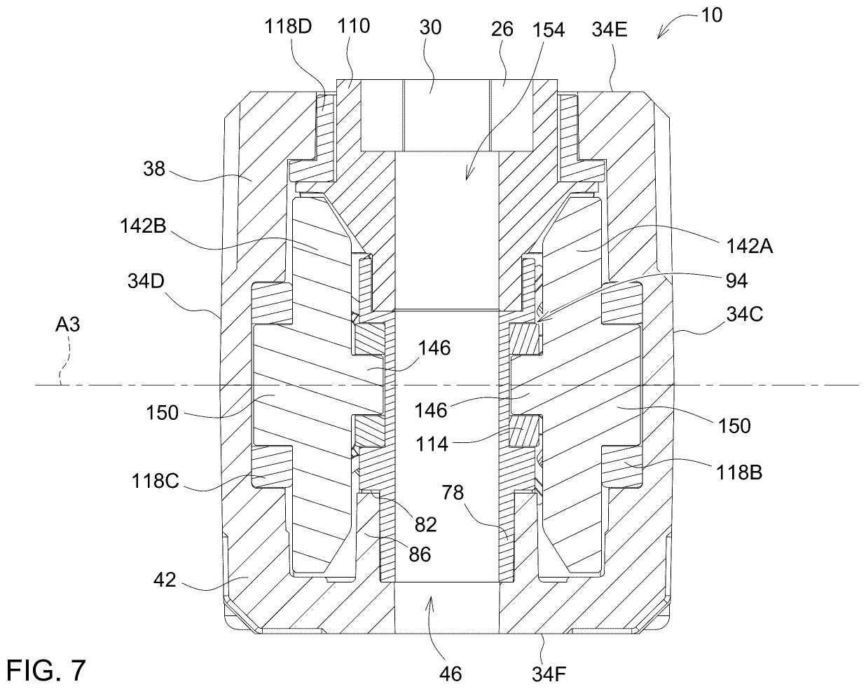

The intermediate bevel gear assembly 106 includes two intermediate bevel gears 142A, 142B (also referred to as intermediate members 142A, 142B). Each intermediate bevel gear 142A, 142B includes an inner projection 146 and an outer projection 150 on a side of the intermediate bevel gear 142A, 142B opposite the inner projection 146. Each inner projection 146 extends through one inner bushing 114 and into the respective bushing retainer 94. Each intermediate bevel gear 142A, 142B is rotatable relative to the respective inner bushing 114. The groove 116 can improve flow of the lubricant between each inner projection 146 and the respective inner bushing 114 to decrease friction as each intermediate bevel gear 142A, 142B rotates relative to the respective inner bushing 114. Each outer projection 150 extends through the respective outer bushing 118B, 118C and into the respective housing notch 66B, 66C. Each intermediate bevel gear 142A, 142B is intermeshed with the first bevel gear 102. More specifically, each intermediate bevel gear 142A, 142B includes a plurality of intermediate teeth 148. The intermediate teeth 148 engage the first teeth 138 of the first bevel gear 102. Rotation of the first bevel gear 102 causes each intermediate bevel gear 142A, 142B to rotate about a third rotational axis A3 (shown in FIG. 7). In the illustrated embodiment, the third rotational axis A3 is perpendicular to the first rotational axis A1. The third rotational axis A3 is also perpendicular to the second rotational axis A2. In other embodiments, the third rotational axis A3 may be obliquely angled relative to the first rotational axis A1 and/or the second rotational axis A2. The intermediate bevel gears 142A, 142B rotate in opposite directions about the third rotational axis A3. In some embodiments, the intermediate bevel gear assembly 106 may only include a single intermediate bevel gear, three intermediate bevel gears, etc.

The second bevel gear 110 is positioned proximate the top side 34E of the housing 14. The second bevel gear 110 includes a bore 154 (FIG. 7) aligned with the second rotational axis A2 of the channel 46. As such, the second bevel gear 110 forms a portion of the channel 46. The second bevel gear 110 also forms a portion of the opening 58. In the illustrated embodiment, the second bevel gear 110 has a U-shape. The second bevel gear 110 is intermeshed with the intermediate bevel gears 142A, 142B. More specifically, the second bevel gear 110 includes a plurality of second teeth 158. The second teeth 158 are positioned on each side of the opening 58. The second teeth 158 engage the intermediate teeth 148 of each intermediate bevel gear 142A, 142B. Rotation of the intermediate bevel gears 142A, 142B causes the second bevel gear 110 to rotate about the second rotational axis A2.

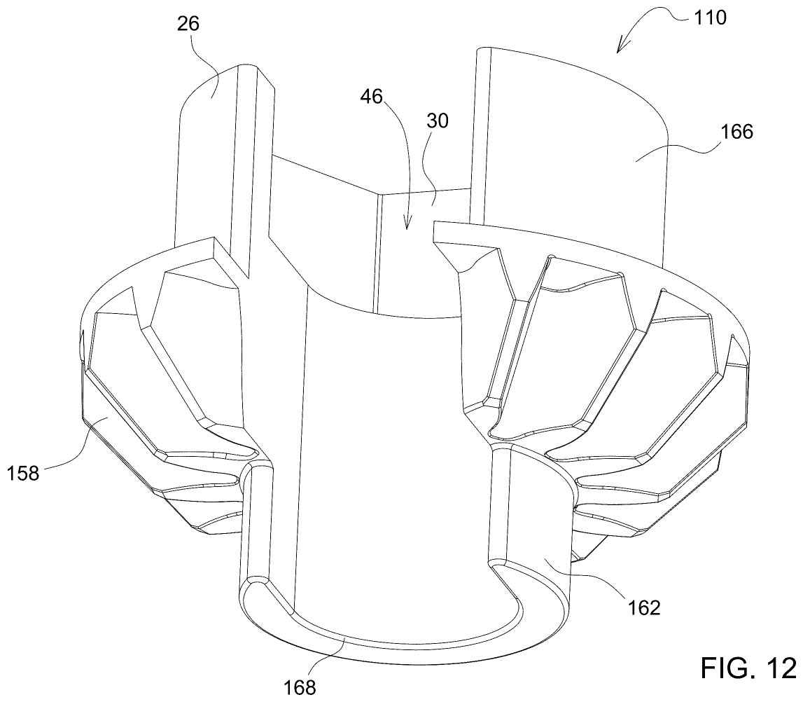

The second bevel gear 110 further includes inner and outer extension members 162, 166 extending therefrom on opposite sides of the second bevel gear 110. The bore 154 extends through each extension member 162, 166. The outer extension member 166 extends through the outer bushing 118D and through the top side 34E of the housing 14. As best illustrated in FIG. 12, the inner extension member 162 includes a flat U-shaped opening 168. In other embodiments, the U-shaped opening 168 can be chamfered, angled, or have any suitable geometry.

The illustrated outer extension member 166 defines the output member 26 and the drive socket 30. As such, the outer extension member 166 is configured to receive the fastener (e.g., hex nut). In other embodiments, the outer extension member 166 can be separate from the output member 26 and coupled to the output member 26.

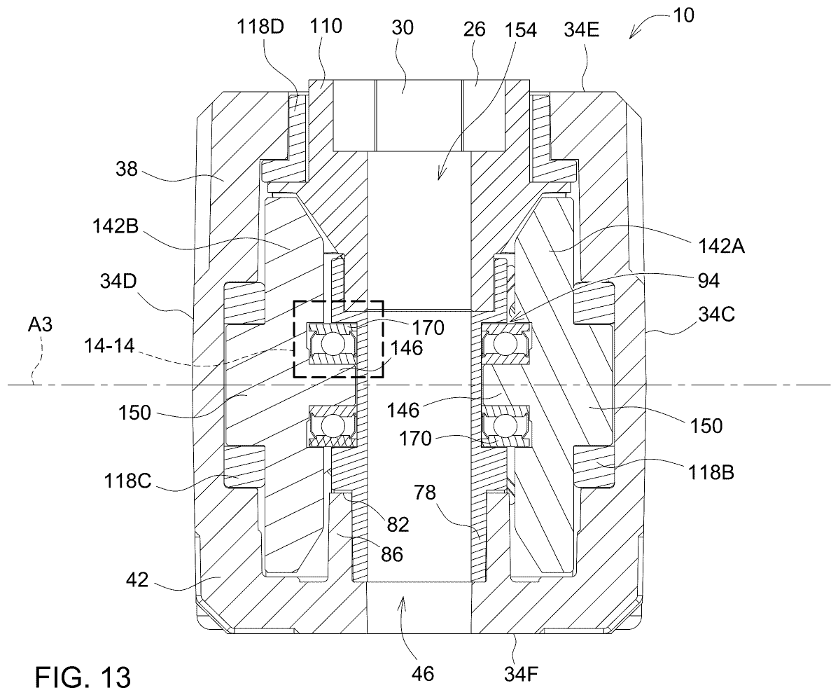

With reference to FIG. 13, the transmission assembly 18 of the fastener driving tool 10 can include a plurality of bearings 170 instead of the plurality of inner bushings 114. Each intermediate bevel gear 142A, 142B is rotatably supported by one bearing 170. The first bevel gear 102 (shown in FIG. 6) can also be rotatably supported by one bearing 170.

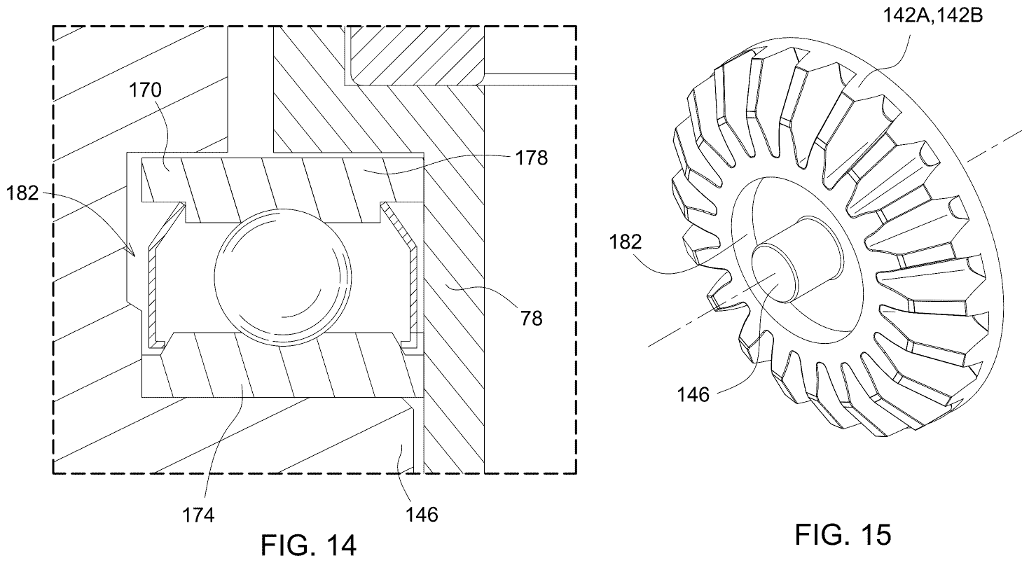

With reference to FIG. 14, each bearing 170 includes an inner race 174 and an outer race 178. For bearings 170 rotatably supporting the intermediate bevel gears 142A, 142B, the inner race 174 is coupled to the inner projection 146, and the outer race 178 is coupled to the tower 78. For the bearing 170 rotatably supporting the first bevel gear 102, the inner race 174 is coupled to the first projection 134, and the outer race 178 is coupled to the tower 78. Each outer race 178 can be received in one respective bushing retainer 94, such that the outer race 178 cannot rotate relative to the tower 78. Each inner race 174 can rotate with the respective first or intermediate bevel gear 102, 142A, 142B relative to the respective outer race 178.

With reference to FIGS. 14 and 15, each intermediate bevel gear 142A, 142B can include a gear recess 182. The gear recess 182 is an annular recess surrounding the inner projection 146. The gear recess 182 provides clearance for the bearing 170 to be received between the tower 78 and the respective intermediate bevel gear 142A, 142B. The gear recess 182 can be any suitable depth and width to receive the bearing 170. The first bevel gear 102 can also include an annular gear recess 182 surrounding the first projection 134. In some embodiments, the gear recesses 182 can receive the inner bushings 114 instead of the bearings 170.

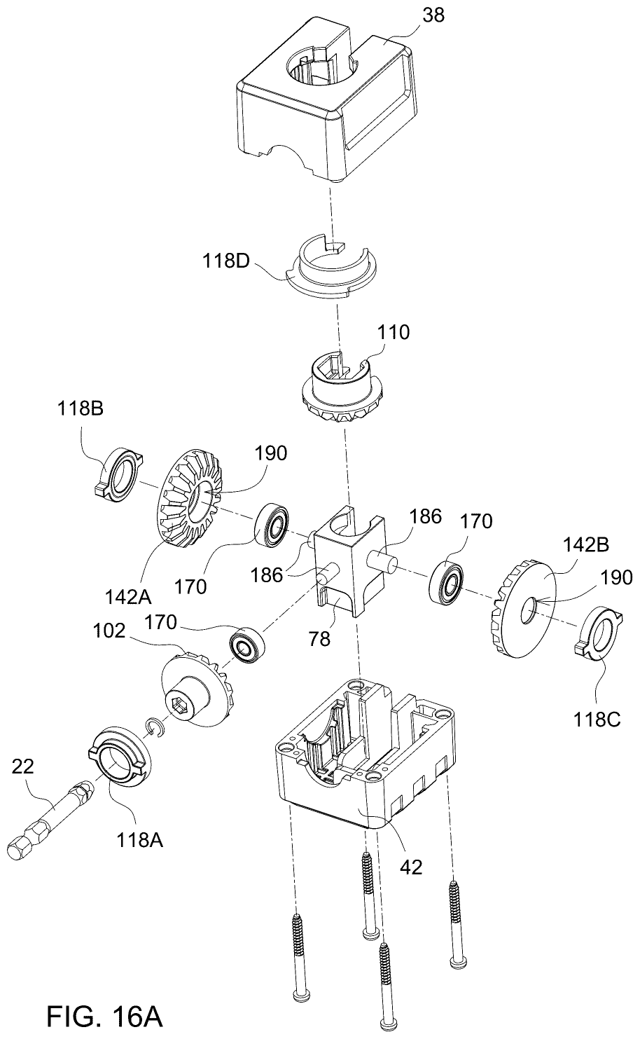

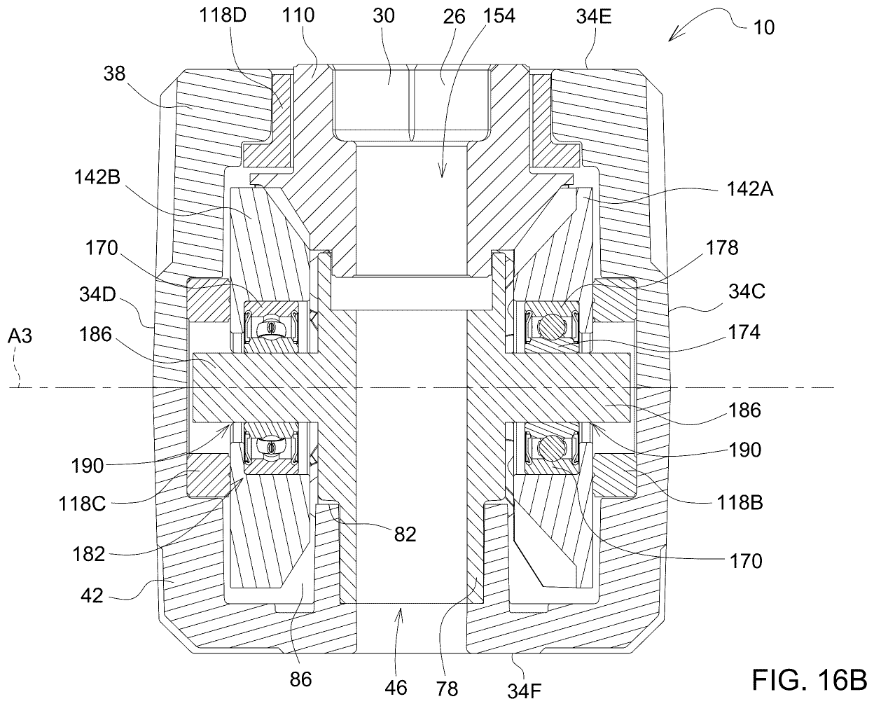

With reference to FIGS. 16A and 16B, the tower 78 can include a plurality of tower shafts 186 extending from the sides of the tower 78. The illustrated tower 78 includes one tower shaft 186 extending through each intermediate bevel gear 142A, 142B and the first bevel gear 102. Each intermediate bevel gear 142A, 142B includes a gear bore 190 extending entirely through the respective intermediate bevel gear 142A, 142B. As such, in embodiments with the tower shafts 186, each intermediate bevel gear 142A, 142B does not include an inner projection 146 or an outer projection 150. Each illustrated tower shaft 186 extends entirely through the respective gear bore 190 and into the respective outer bushing 118B, 118C. The first bevel gear 102 includes a gear bore 190 extending into the first bevel gear 102. Each inner race 174 of the respective bearing 170 is coupled to the respective tower shaft 186. Each outer race 178 of the respective bearing 170 is coupled to the respective intermediate bevel gear 142A, 142B and first bevel gear 102. Each inner race 174 can be coupled to the respective tower shaft 186, such that the inner race 174 cannot rotate relative to the tower shaft 186. Each outer race 178 can rotate with the respective intermediate bevel gear 142A, 142B or first bevel gear 102 relative to the respective inner race 174. In some embodiments, each gear bore 190 may extend only partially through the respective intermediate bevel gear 142A, 142B. In these embodiments, each tower shaft 186 may extend only partially through the respective intermediate bevel gear 142A, 142B.

When assembled, the first bevel gear 102 is intermeshed with the intermediate bevel gear assembly 106, and the intermediate bevel gear assembly 106 is intermeshed with the second bevel gear 110. Accordingly, rotation of the input shaft 22 is configured to drive rotation of the second bevel gear 110 including the drive socket 30. The channel 46 is configured to receive a threaded shaft or rod (not shown) such that rotation of the drive socket 30 drives the fastener (e.g., hex nut) onto the threaded rod.

The transmission assembly 18 can have any suitable gear ratio to adjust the speed and forces transferred to the drive socket 30. For example, the first and second bevel gears 102, 110 can include fifteen first and second teeth 138, 158, respectively, and each intermediate bevel gear 142A, 142B can include twenty intermediate teeth 148. In other embodiments, each of the gears 102, 110, 142A, 142B can include fewer or more teeth. Additionally or alternatively, the gears 102, 110, 142A, 142B may include the same number of teeth or different numbers of teeth relative to each other.

In some embodiments of the driving tool 10 (e.g., embodiments including only one intermediate bevel gear, three intermediate bevel gears, etc.), the driving tool 10 may be further provided with additional gears. The additional gears may be positioned within the housing 14, and proximate the opening 58. The additional gears may be movable (e.g., pivotable) relative to the opening 58 to selectively cover and uncover the opening 58 such that the second bevel gear 110 continues rotation with the rotation of the intermediate bevel gear assembly 106.

In operation, the threaded rod is positioned within the channel 46. A torque is applied by the power tool to the input shaft 22 to drive rotation of the input shaft 22. The rotation of the input shaft 22 drives rotation of the first bevel gear 102 about the first rotational axis A1. Concurrently, the intermediate bevel gear assembly 106 is driven to rotate (about the third rotational axis A3) via engagement between the first teeth 138 of the first bevel gear 102 and the intermediate teeth 148 of the intermediate bevel gear assembly 106. Furthermore, the second bevel gear 110 is driven to rotate about the second rotational axis A2 via engagement between the intermediate teeth 138 of the intermediate bevel gear assembly 106 and the second teeth 158 of the second bevel gear 110. The radial lugs 122 of the outer bushings 118A-118D inhibit the outer bushings 118A-118D from rotating with the first bevel gear 102, the intermediate bevel gear assembly 106, and the second bevel gear 110. This reduces wear and allows the first bevel gear 102, the intermediate bevel gear assembly 106, and the second bevel gear 110 to rotate relative to stationary bushings 118A-118D. The fastener is positioned about a portion of the threaded rod and in the drive socket 30 of the second bevel gear 110 for rotation with the second bevel gear 110. Accordingly, the drive tool 10 converts the torque applied to the input shaft 22 to generate rotation of the input shaft 22 about the first rotational axis A1 to rotation of the drive socket 30 about the second rotational axis A2.

Advantageously, the channel 46 extends through the housing 14 such that threaded rods of any predetermined length may be received in the channel 46. In particular, the driving tool 10 is adapted for driving fasteners on threaded rods having a relatively large length (e.g., 18 inches or greater). In addition, the channel 46 is in connection with the open second side 34B of the housing 14 (via the opening 58) such that a user has access to the fastener in the drive socket 30 and/or the threaded rod in the channel 46.

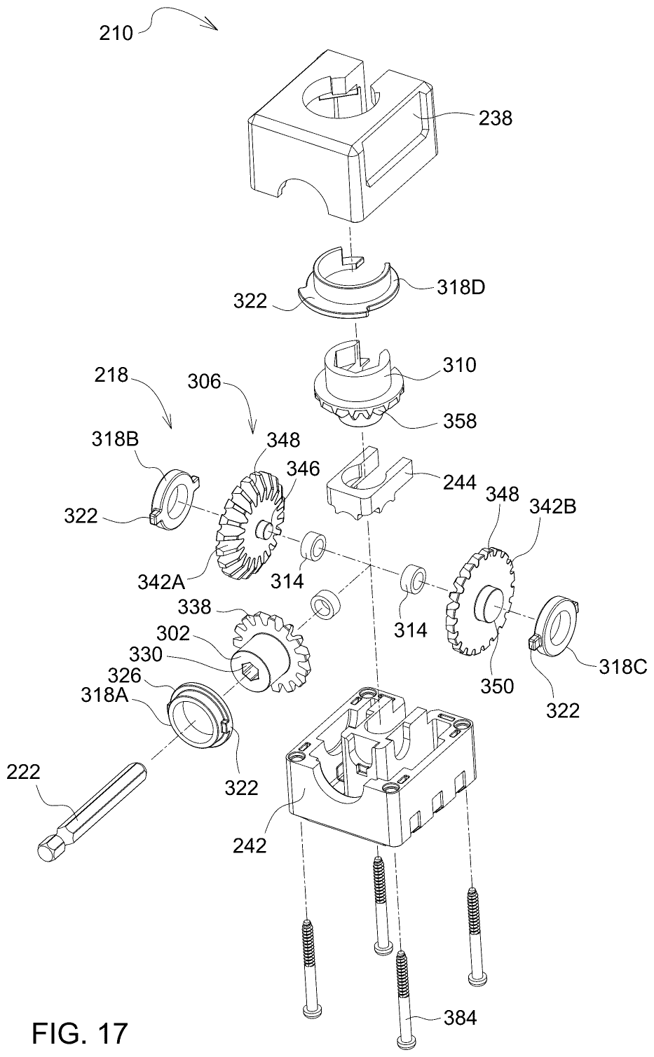

FIGS. 17-19 illustrate a fastener driving tool 210 similar to the fastener driving tool 10. For brevity, only the differences between the fastener driving tool 210 and the fastener driving tool 10 are described. Components in the fastener driving tool 210 will be labeled the same as like components in the fastener driving tool 10 plus a value of 200. For example, the fastener driving tool 210 includes an upper housing portion 238 similar to the upper housing portion 238. It should be appreciated that the fastener driving tool 210 can include any components described with reference to the fastener driving tool 10, and the components can have the same features and function. In addition, alternatives to the components described above with respect to the fastener driving tool 10 are also applicable to the fastener driving tool 210.

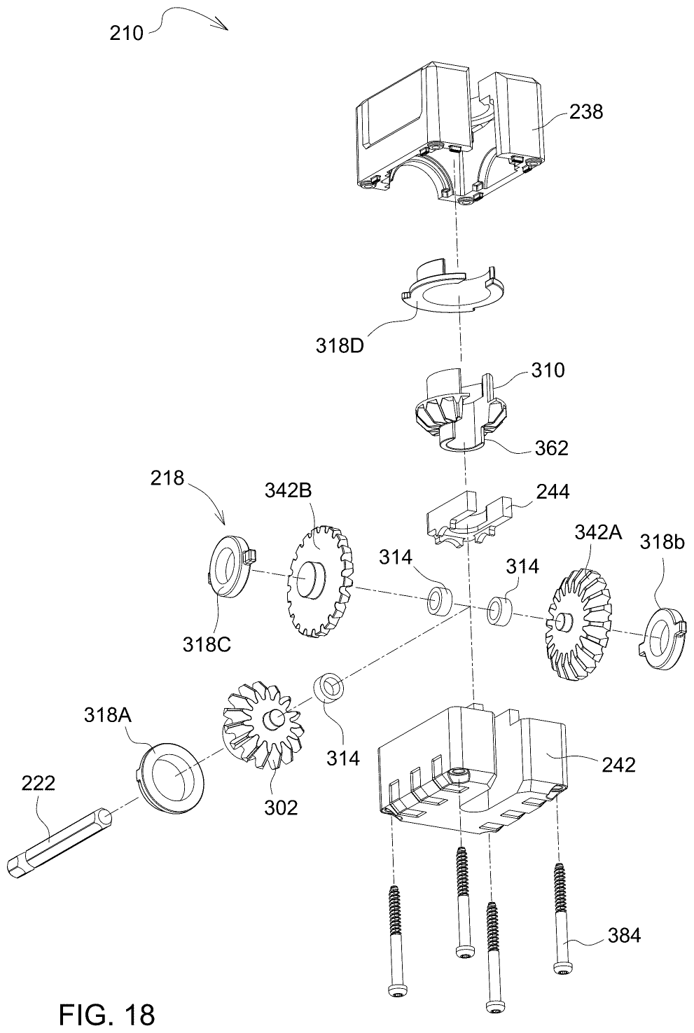

With reference to FIGS. 17 and 18, the fastener driving tool 210 includes the upper housing portion 238 and a lower housing portion 242 coupled together by a plurality of fasteners 384. In the illustrated embodiment, the fasteners 384 are threaded fasteners, such as bolts or screws. The illustrated fasteners 384 extend through the entire lower housing portion 242 and into the upper housing portion 238.

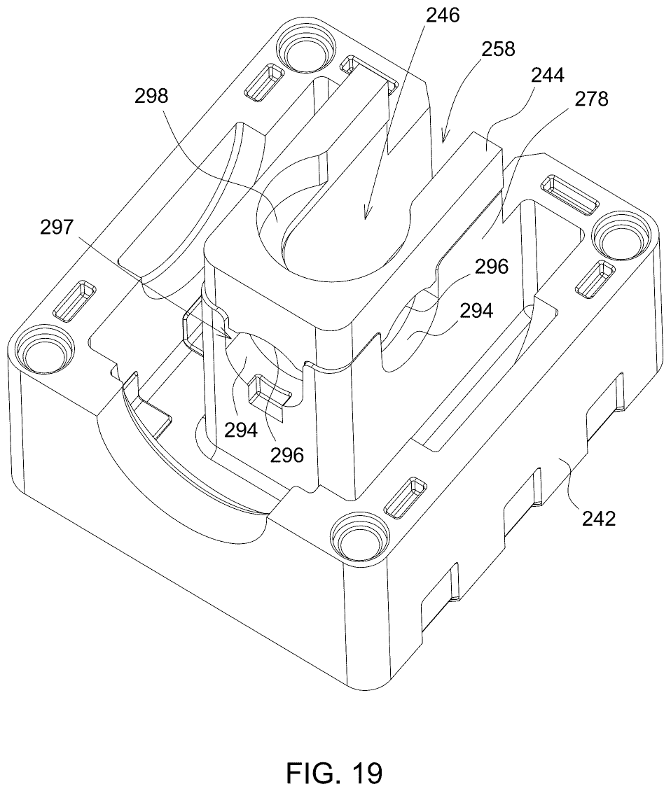

With reference to FIG. 19, the fastener driving tool 210 includes a saddle 244 coupled to the lower housing portion 242. The lower housing portion 242 includes a tower portion 278. In the illustrated embodiment, the tower portion 278 is integrally formed as a single piece (e.g., molded) with the rest of the lower housing portion 242. The tower portion 278 extends from the lower housing portion 242 toward the upper housing portion 238. The tower portion 278 includes tower bushing retainers 294. The tower bushing retainers 294 are U-shaped depressions in the tower portion 278. The tower bushing retainers 294 assist in securing the transmission assembly 218 to the lower housing portion 242.

The saddle 244 is connected to a top side of the lower housing portion 242. In particular, the saddle 244 is connected to a top side of the tower portion 278 of the lower housing portion 242. The saddle 244 includes saddle bushing retainers 296. The saddle bushing retainers 296 are arcuate projections extending from the saddle 244 toward the lower housing portion 242. Together, each tower bushing retainer 294 and the adjacent saddle bushing retainer 296 defines a circular area shaped to receive the inner bushings 314. It should be appreciated that each pair of adjacent tower bushing retainers 294 and saddle bushing retainers 296 can be referred to as a retaining portion 297. In the illustrated embodiment, the tower portion 278 includes three tower bushing retainers 294 that engage with three saddle bushing retainers 296, respectively. Alternatively, the tower bushing retainers 294 can receive the bearings 170 (shown in FIG. 13).

The saddle 244 further defines the channel 246 and the opening 258. As such, the saddle 244 has a U-shape. The saddle 244 also includes a saddle seat 298. The illustrated saddle seat 298 is on a top side of the saddle 244 and surrounds the channel 246. The saddle seat 298 assists in securing the transmission assembly 218 to the saddle 244. More specifically, the inner extension member 362 of the second bevel gear 310 extends into the saddle 244 and engages the saddle seat 298. Similar to the tower 78 shown in FIG. 10, the saddle 244 is composed of a rigid material to improve the strength of the fastener driving tool 210. The saddle 244 can be composed of a metal (e.g., aluminum, steel, etc.) or any suitable material to improve the strength of the fastener driving tool 210.

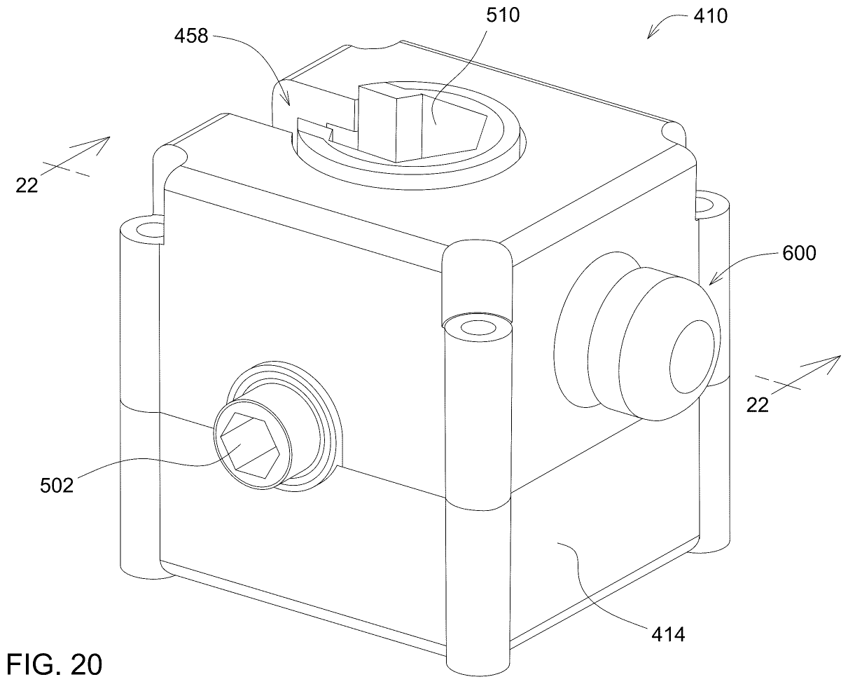

FIGS. 20-22 illustrate a fastener driving tool 410 similar to the fastener driving tools 10, 210. For brevity, only the differences between the fastener driving tool 410 and the fastener driving tools 10, 210 are described. Components in the fastener driving tool 410 will be labeled the same as like components in the fastener driving tool 10 plus a value of 400. For example, the fastener driving tool 410 includes a first bevel gear 502 similar to the first bevel gear 102. It should be appreciated that the fastener driving tool 410 can include any components described with reference to the fastener driving tools 10, 210, and the components can have the same features and function. In addition, alternatives to the components described above with respect to the fastener driving tools 10, 210 are also applicable to the fastener driving tool 410.

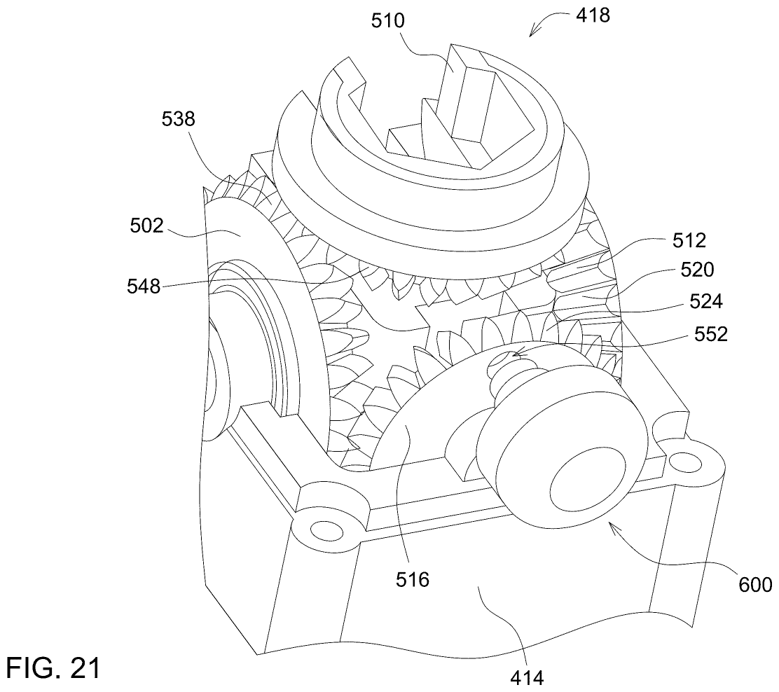

With reference to FIG. 21, the transmission assembly 418 includes the first bevel gear 502, the second bevel gear 510, a third bevel gear 512, and a side bevel gear 516 (also referred to as a side member 516). The third bevel gear 512 includes a plurality of third teeth 520, and the side bevel gear 516 includes a plurality of side teeth 524. The side teeth 524 are meshed with the first teeth 538 of the first bevel gear 502 and the third teeth 520. The first teeth 538 and the third teeth 520 are also meshed with the second teeth 548 of the second bevel gear 510. As such, when the power tool rotates the first bevel gear 502, the side bevel gear 516 is rotated, which rotates the third bevel gear 512. Rotation of the first and third bevel gears 502, 512 rotates the second bevel gear 510. The second bevel gear 510 has the same number of second teeth 548 as the side bevel gear 516 has side teeth 524. As such, during operation, the second bevel gear 510 and the side bevel gear 516 have the same angular speed, which is described in further detail below.

With continued reference to FIG. 21, the side bevel gear 516 includes a reset aperture 552. The reset aperture 552 is selectively engaged by a reset assembly 600 to selectively prevent rotation of the transmission assembly 418.

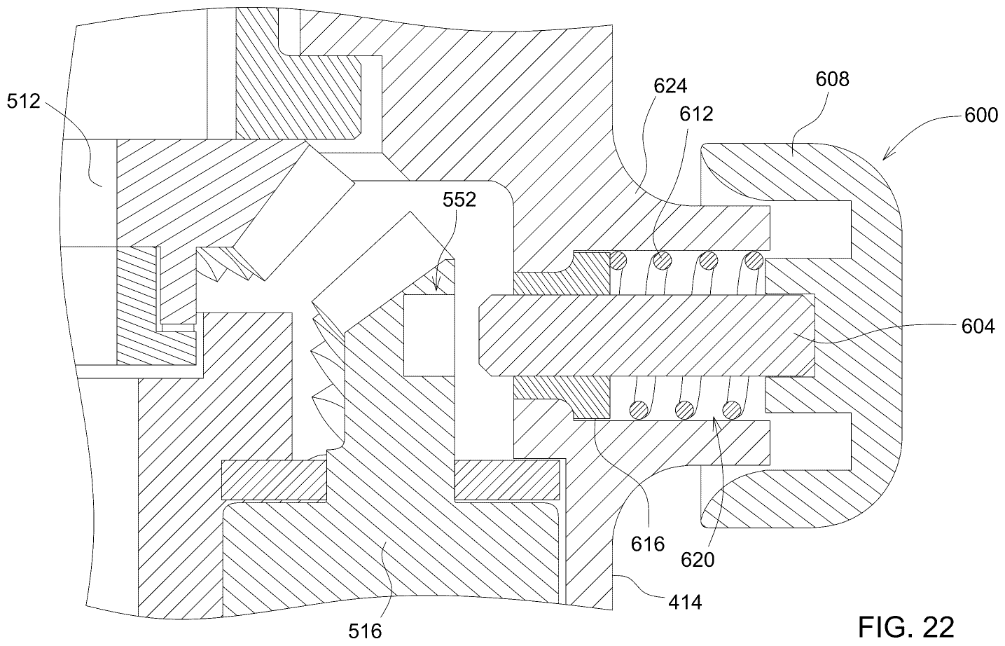

With reference now to FIG. 22, the illustrated reset assembly 600 includes a pin 604, a button 608 coupled to the pin 604, a biasing member 612 to bias the pin 604 away from the reset aperture 552, and a collar 616. The reset assembly 600 is positioned in a recess 620 defined by the housing 414. More specifically, the housing 414 includes a reset projection 624 extending from a surface of the housing 414. The recess 620 extends through the reset projection 624. The collar 616 is housed in the recess 620 adjacent the side bevel gear 516. The biasing member 612 is positioned between the collar 616 and the button 608. The biasing member 612 biases the pin 604 into a disengaged position (i.e., away from the reset aperture 552). The button 608 can be pressed against the bias of the biasing member 612 to move the pin 604 toward the side bevel gear 516 and into the reset aperture 552.

During operation, the portion of the opening 458 defined by the second bevel gear 510 can become misaligned with the rest of the opening 458. When this occurs, the threaded rod can only be removed from the opening 458 in an axial direction (i.e., a direction along the second rotational axis A402). To realign the portion of the opening defined by the second bevel gear 510 with the rest of the opening 458, the pin 604 can be pressed into the reset aperture 552. Once the pin 604 is received in the reset aperture 552, rotation of the transmission assembly 418 is prevented, and the entire opening 458 is aligned, such that the threaded rod can be removed from the opening 458 in a radial direction. Because the second bevel gear 510 has the same number of second teeth 548 as the side bevel gear 516 has side teeth 524, the pin 604 received in the reset aperture 552 always results in the alignment of the entire opening 458.

When the pin 604 is inserted into the reset aperture 552 while the side bevel gear 516 is rotating, the pin 604 can receive shear forces from the side bevel gear 516. To inhibit stresses experienced by the pin 604, the collar 616 absorbs some of the shear forces. The collar 616 can also distribute some of the forces to, for example, the housing 414. To better absorb and distribute forces, the collar 616 is composed of a rigid material such as metal.

In some embodiments, the reset assembly 600 may be located on a different side of the housing 414 and may engage a different gear of the transmission assembly 418. For example, the reset assembly 600 may be configured to selectively engage the first bevel gear 502 or the third bevel gear 512. In addition, the rest assembly 600 may be used with either of the fastener driving tool 10, 210 described above.

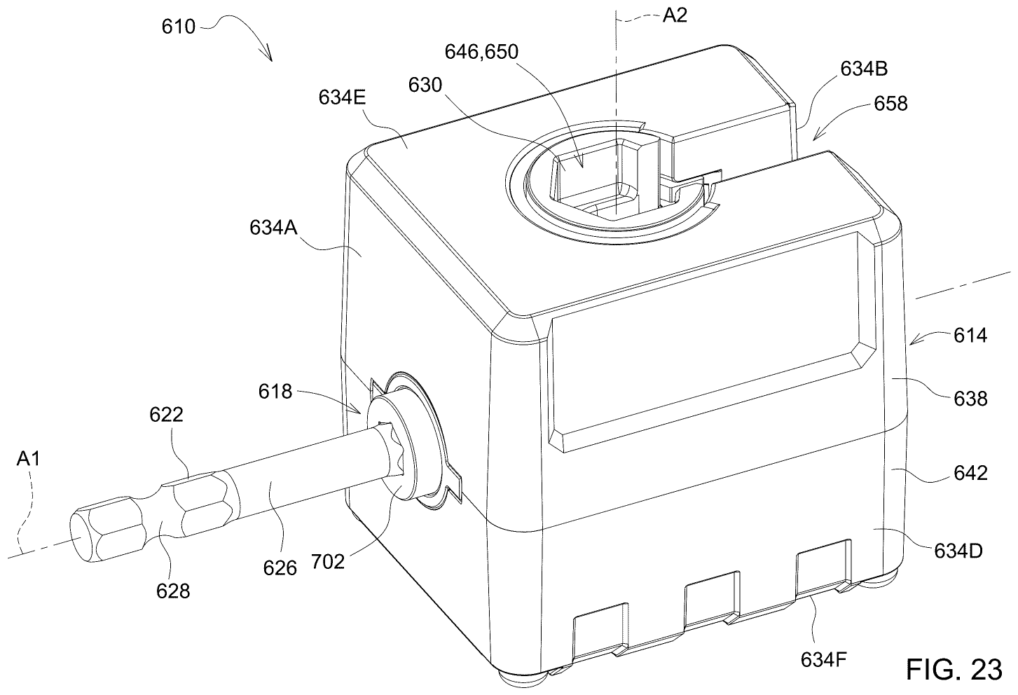

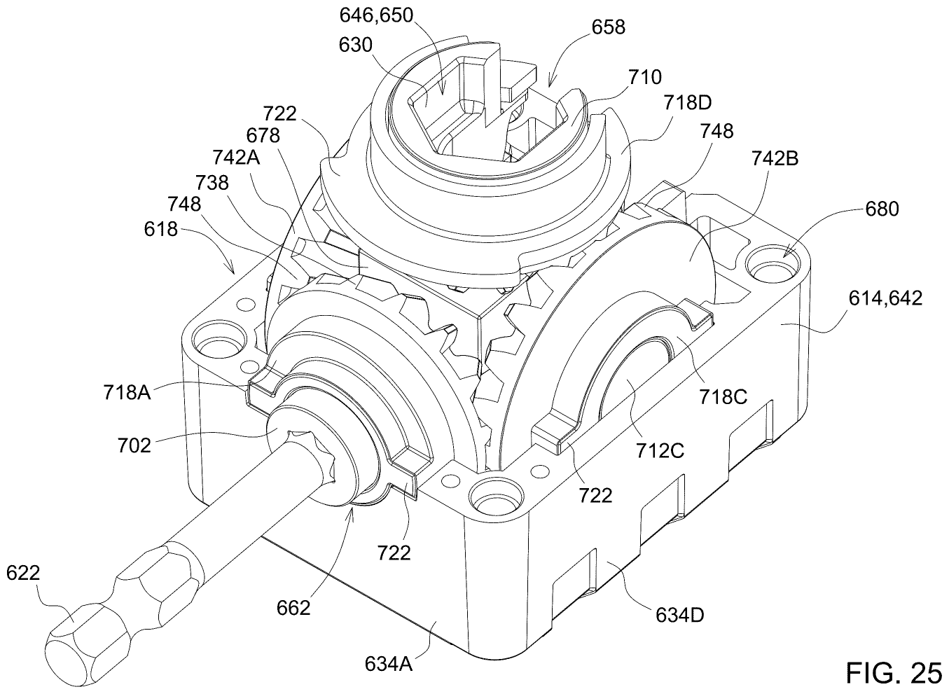

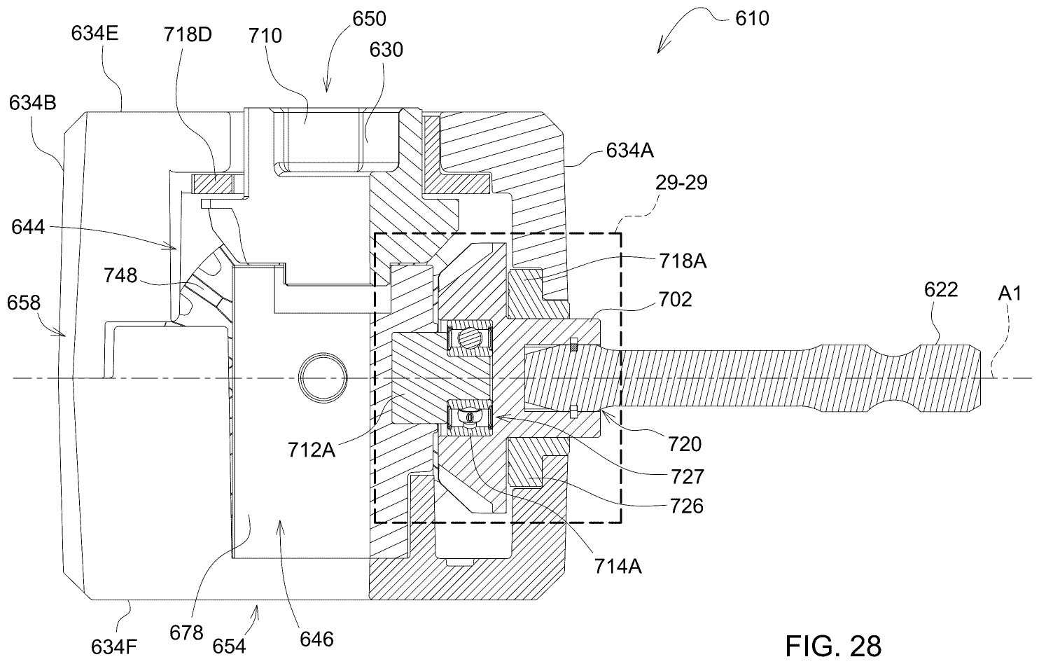

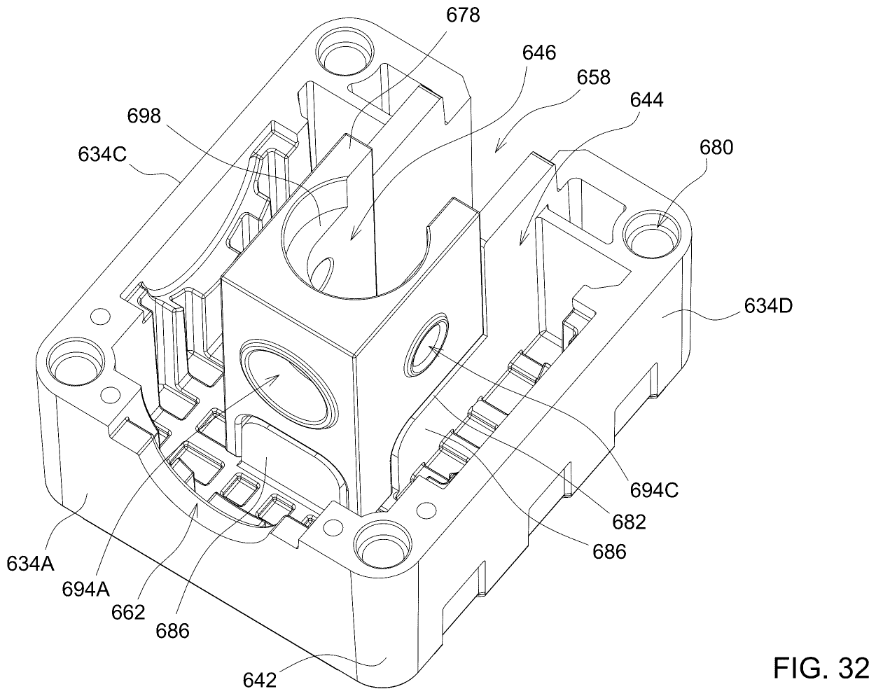

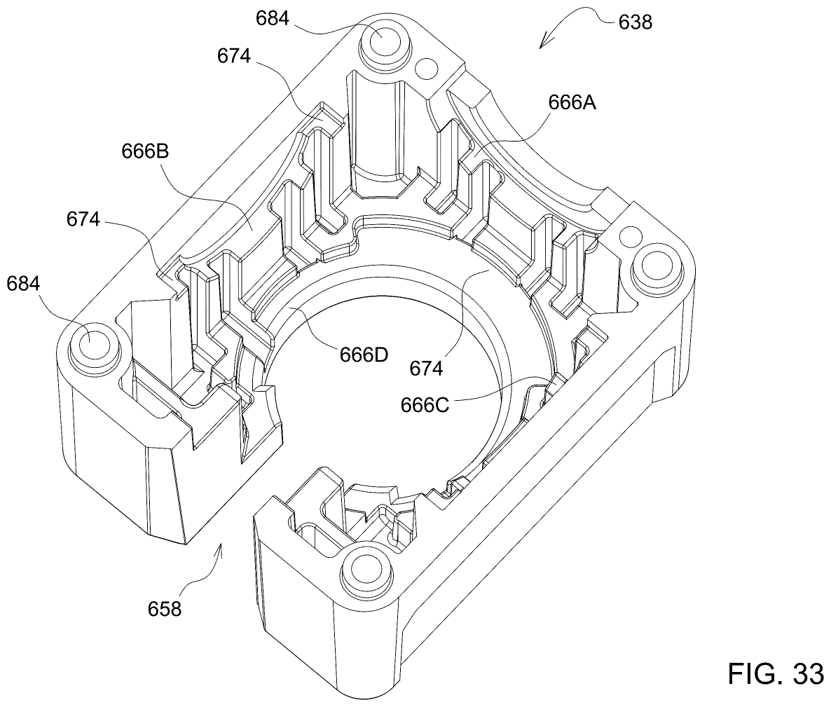

FIGS. 23-35 illustrate a fastener driving tool 610 similar to the fastener driving tools 10, 210, 410. For brevity, only the differences between the fastener driving tool 610 and the fastener driving tools 10, 210, 410 are described. Components in the fastener driving tool 610 will be labeled the same as like components in the fastener driving tool 10 plus a value of 600. For example, the fastener driving tool 610 includes a housing 614 similar to the housing 14. It should be appreciated that the fastener driving tool 610 can include any components described with reference to the fastener driving tools 10, 210, 410, and the components can have the same features and function. In addition, alternatives to the components described above with respect to the fastener driving tools 10, 210, 410 are also applicable to the fastener driving tool 610.

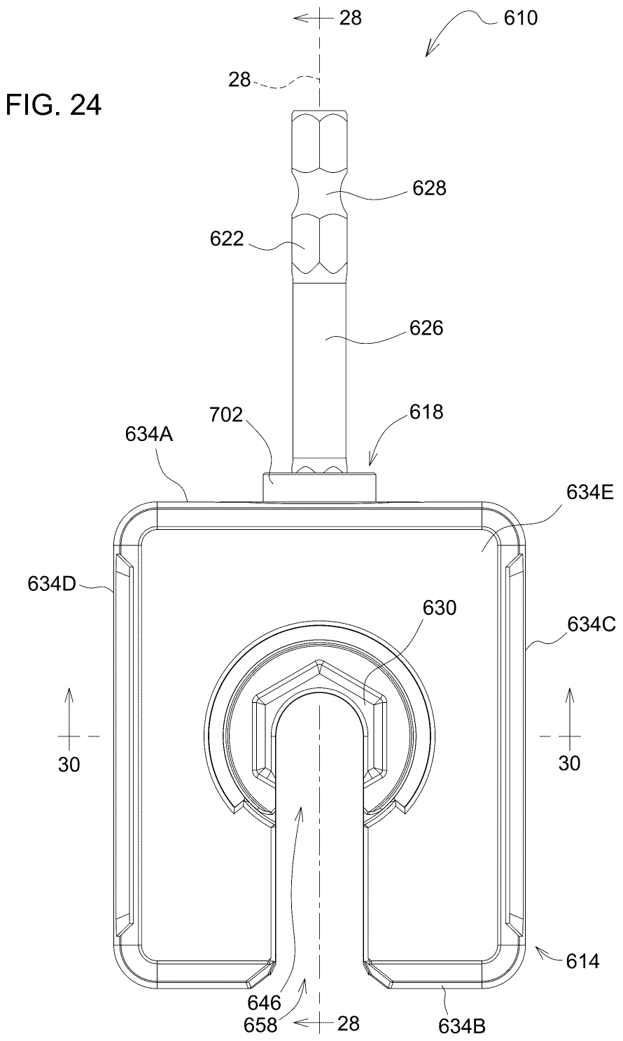

With reference to FIGS. 23 and 24, the fastener driving tool 610 includes an input shaft 622 (also referred to as a shank 622). The input shaft 622 includes a first reduced diameter portion 626 and a second reduced diameter portion 628. The first reduced diameter portion 626 is adjacent a first bevel gear 702 when the input shaft 622 is coupled to the first bevel gear 702. The first reduced diameter portion 626 is positioned between the first bevel gear 702 and the second reduced diameter portion 628 when the input shaft 622 is coupled to the first bevel gear 702. The first and second reduced diameter portions 626, 628 remove localized regions of high stress and discontinuities, thereby increasing the durability and lifetime of the input shaft 622. In other embodiments, the input shaft 622 can include any suitable number of reduced diameter portions to increase the durability and lifetime of the input shaft 622 (e.g., one, three, four, etc.).

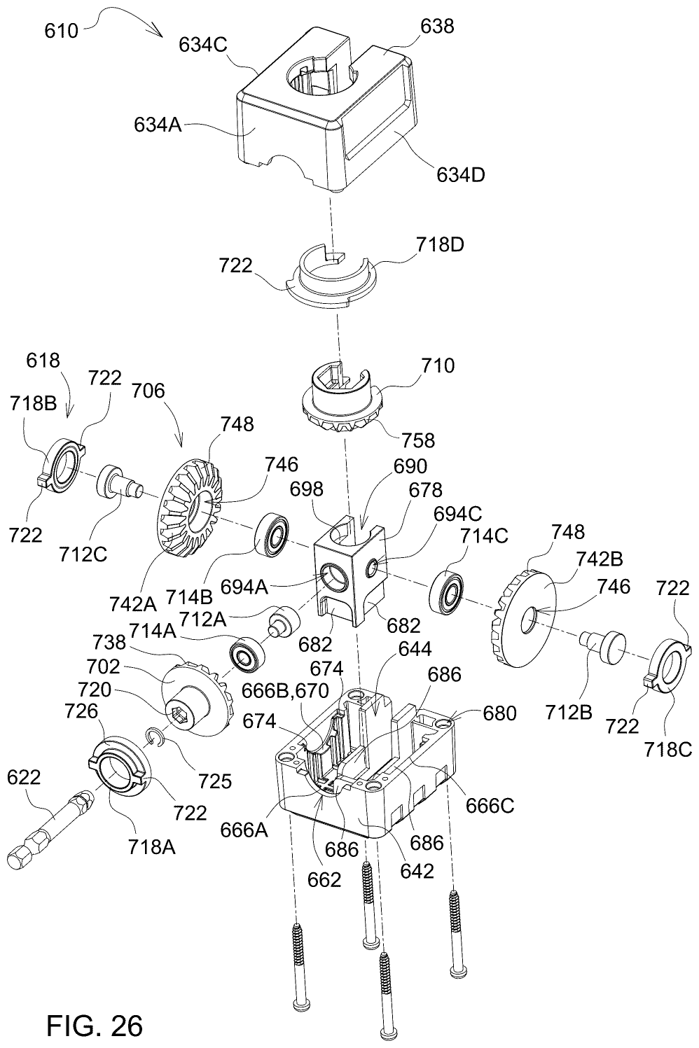

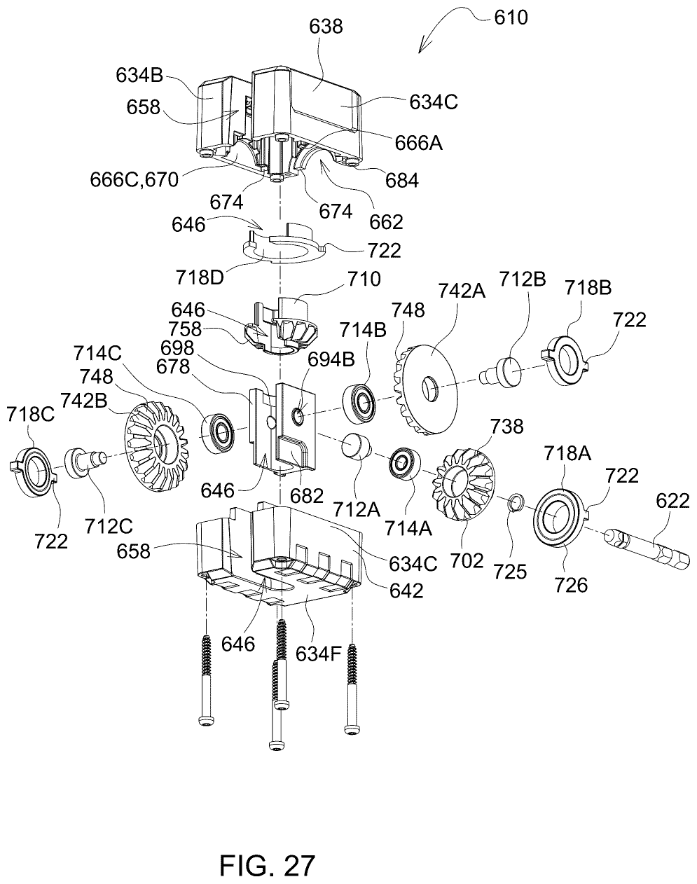

With reference to FIGS. 26 and 27, the fastener driving tool 610 includes a tower 678 positioned in a cavity 644 defined by the housing 614. The tower 678 includes a plurality of shaft bores 694A-694C. The shaft bores 694A-694C assist in securing a transmission assembly 618 to the tower 678. Each shaft bore 694A-694C is positioned above one tower notch 682. The illustrated tower 678 includes a first shaft bore 694A extending through a portion of the tower 678 adjacent the front side 634A of the housing 614, a second shaft bore 694B extending through a portion of the tower 678 adjacent the side 634C of the housing 614, and a third shaft bore 694C extending through a portion of the tower 678 adjacent the side 634D of the housing 614. The illustrated first shaft bore 694A is larger than the second and third shaft bores 694B, 694C. In some embodiments, the first shaft bore 694A can be the same size as or larger than the second and third shaft bores 694B, 694C.

With continued reference to FIGS. 26 and 27, the transmission assembly 618 includes a plurality of shafts 712A-712C and a plurality of bearings 714A-714C for rotatably supporting the first bevel gear 702, an intermediate bevel gear assembly 706, and a second bevel gear 710 by the tower 678. The transmission assembly 618 further includes a plurality of bushings 718A-718D for rotatably supporting the first bevel gear 702, the intermediate bevel gear assembly 706, and the second bevel gear 710 by the housing 614.

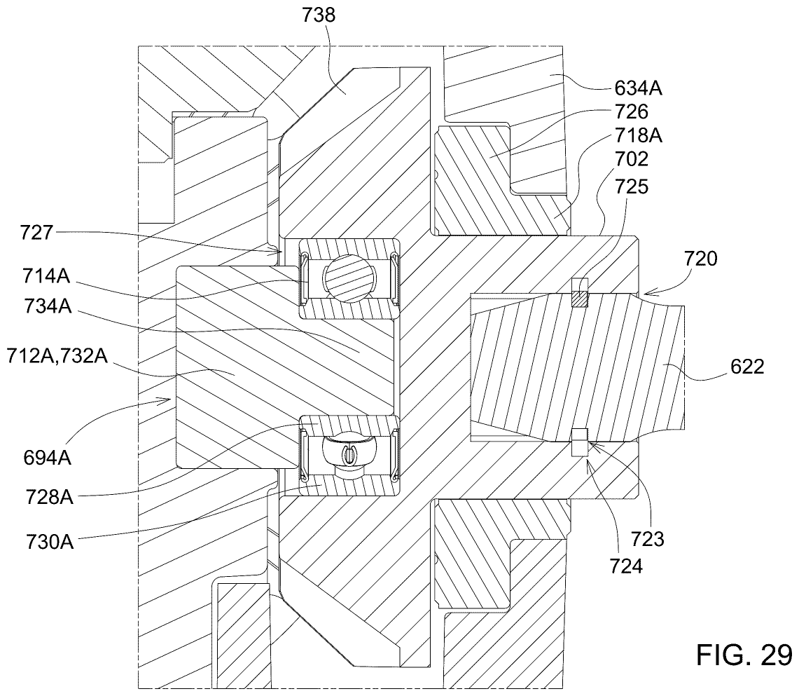

With reference to FIG. 29, the input shaft 622 includes an annular groove 723, and the first bevel gear 702 includes a channel 724 extending around the outer bore 720. The fastener driving tool 610 includes a ring 725 (e.g., a C-ring) received in the annular groove 723 and the channel 724 to improve the connection between the input shaft 622 and the first bevel gear 702. In other embodiments, the input shaft 622 can be permanently coupled to the first bevel gear 702 by, for example, welding, adhesives, fasteners, etc.

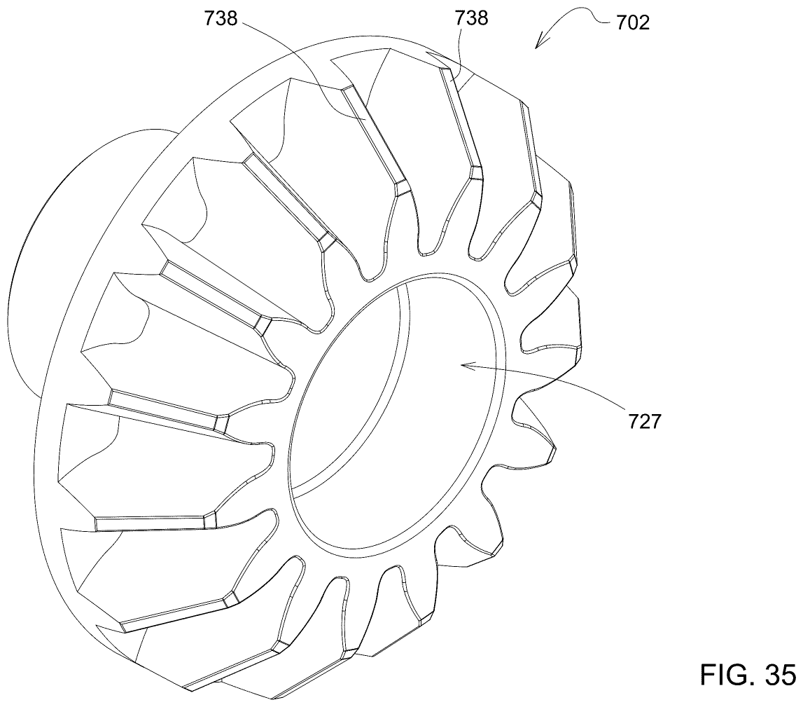

With continued reference to FIG. 29, the first bevel gear 702 is coupled to the tower 678 for rotation relative to the tower 678. In the illustrated embodiment, the first bevel gear 702 includes an inner bore 727 (shown in FIG. 35) on a side of the first bevel gear 702 opposite the outer bore 720. The inner bore 727 receives the first bearing 714A and the first bushing 718A. More specifically, the first bearing 714A includes an inner race 728A and an outer race 730A. The outer race 730A is coupled to the surface of the inner bore 727, such that the outer race 730A rotates with the first bevel gear 702. The first shaft 712A includes a head 732A and a body 734A extending from the head 732A. The head 732A is larger (e.g., has a larger diameter) than the body 734A. The head 732A is received in the tower 678. More specifically, the head 732A is received in the first shaft bore 694A of the tower 678. The body 734A is received in the inner race 728A of the first bearing 714A, which is positioned within the inner bore 727 of the first bevel gear 702. More specifically, the body 734A is coupled to the inner race 728A such that the body 734A inhibits rotation of the inner race 728A. The body 734A secures the inner race 728A such that the outer race 730A (and the first bevel gear 702) rotate relative to the inner race 728A. In the illustrated embodiment, the entire first bearing 714A and the entire body 734A are received in the inner bore 727. In other embodiments, the first bearing 714A and/or the body 734A can be only partially received in the inner bore 727. The first bevel gear 702 also includes a plurality of first teeth 738.

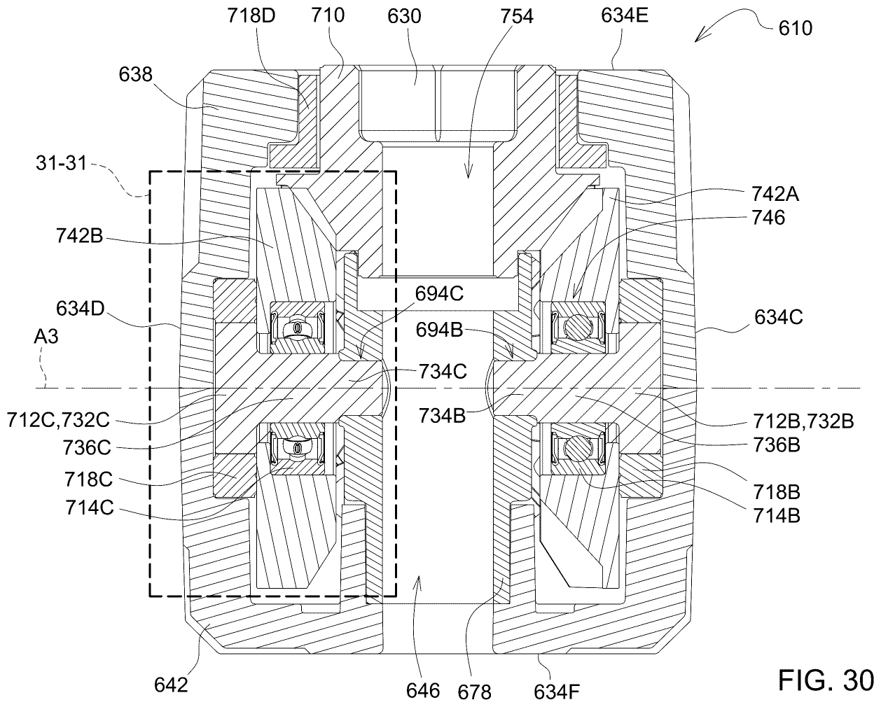

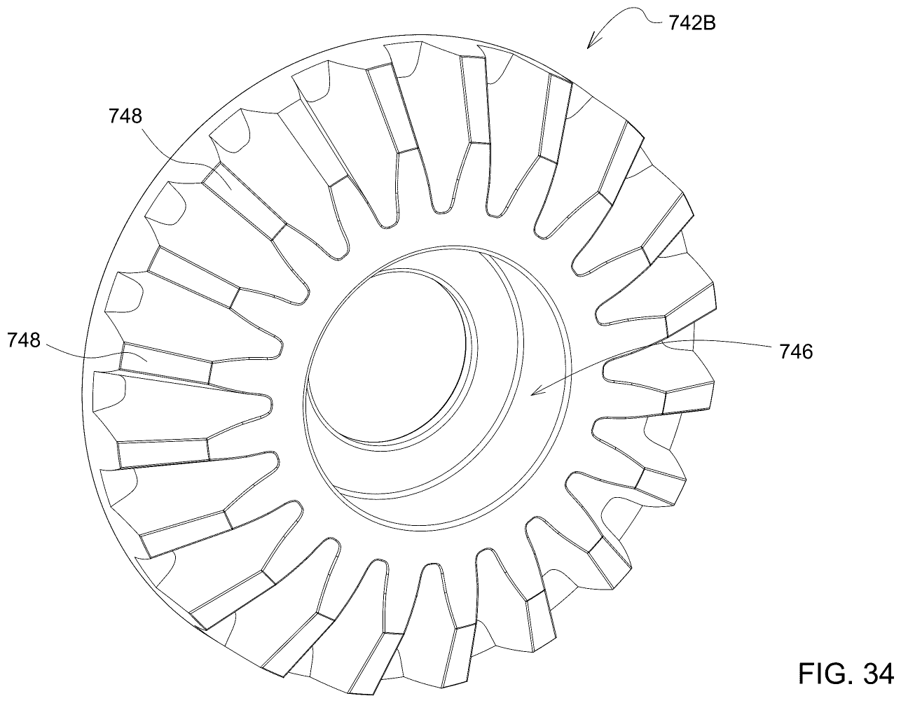

With reference to FIG. 30, the intermediate bevel gear assembly 706 includes two intermediate bevel gears 742A, 742B. Each intermediate bevel gear 742A, 742B is coupled to the housing 614 and the tower 678 for rotation relative to the housing 614 and the tower 678. In the illustrated embodiment, each intermediate bevel gear 742A, 742B includes an aperture 746 extending through the intermediate bevel gear 742A, 742B. The aperture 746 through the intermediate bevel gear 742B is illustrated in FIG. 34. Each aperture 746 receives a respective shaft 712B, 712C and bearing 714B, 714C.

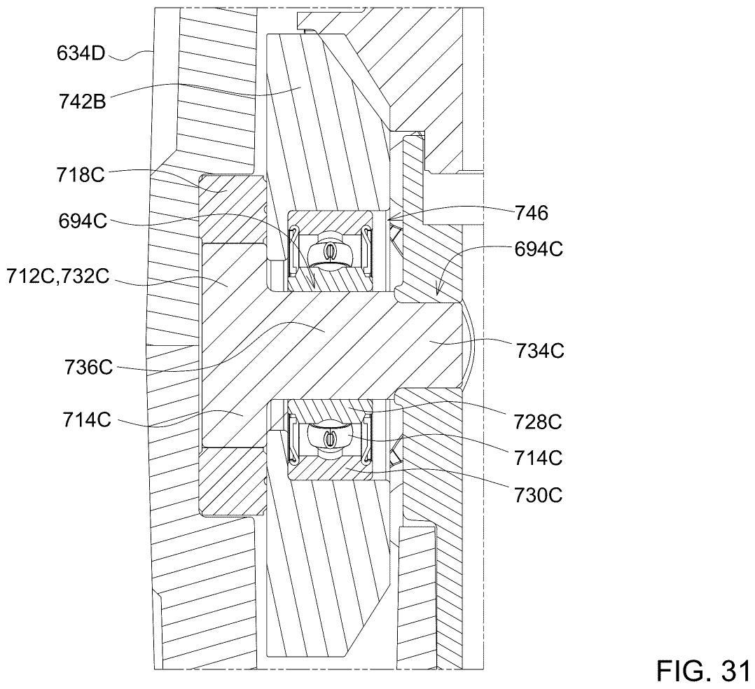

With reference to FIG. 31, the bearing 714C includes an inner race 728C and an outer race 730C. Although FIG. 31 only shows one intermediate bevel gear 742B and corresponding shaft 712C and bearing 714C, the other intermediate bevel gear 742A and corresponding shaft 712B and bearing 714B are the same. The outer race 730C is coupled to an inner surface of the aperture 746, such that the outer race 730C rotates with the intermediate bevel gear 742B. The third shaft 712C includes a head 732C, an end portion 734C opposite the head 732C, and an intermediate portion 736C positioned between the head 732C and the end portion 734C. The intermediate portion 736C is larger than the end portion 734C, and the head 732C is larger than the intermediate portion 736C. The end portion 734C is received in the shaft bore 694C. More specifically, the end portion 734C is coupled to the shaft bore 694C such that the tower 678 inhibits rotation of the shaft 712C. The intermediate portion 736C is received in the inner race 728C. More specifically, the intermediate portion 736C is coupled to the inner race 728C such that the intermediate portion 736C inhibits rotation of the inner race 728C. The intermediate bevel gear 742B and the outer race 730C are configured to rotate relative to the intermediate portion 736C. The head 732C is received in and coupled to the outer bushing 718C. It should be appreciated that the intermediate bevel gear 742A, the bearing 714B, and the shaft 712B can include any components, features, and function as described herein with reference to the intermediate bevel gear 742B, the bearing 714C, and the shaft 712C, respectively.

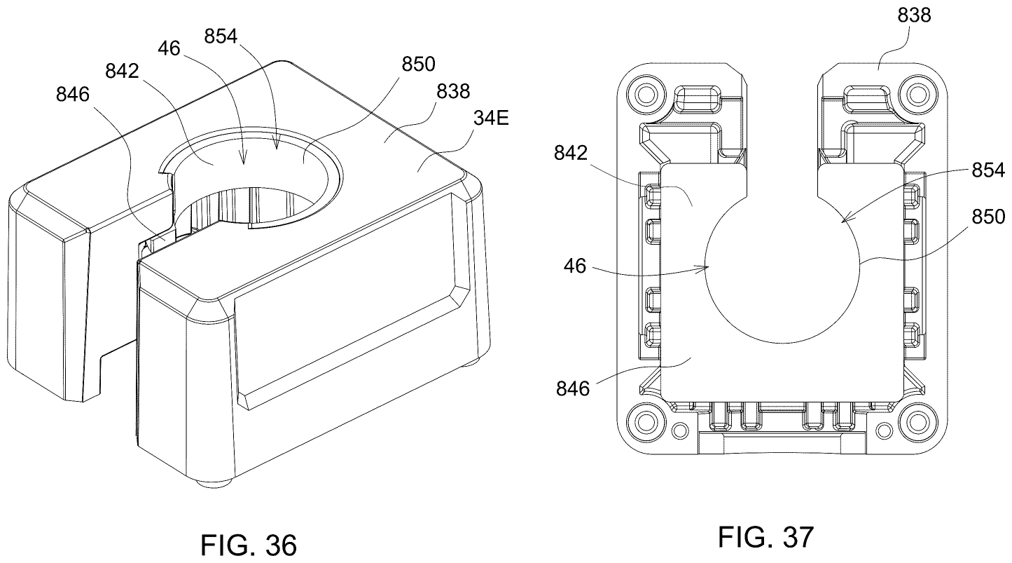

FIGS. 36-38 illustrate an embodiment of an upper housing portion 838 for use in a fastener driving tool (e.g., the fastener driving tool 10). The upper housing portion 838 is similar to the upper housing portions 38, 238. For brevity, only the differences between the upper housing portion 838 and the upper housing portions 38, 238 are described. Components of the upper housing portion 838 will be labeled the same as like components of the upper housing portion 38 plus a value of 800. It should be appreciated that the upper housing portion 838 can include any components described with reference to the upper housing portions 38, 238, and the components can have the same features and function. In addition, alternatives to the components described above with respect to the upper housing portions 38, 238 are also applicable to the upper housing portion 838.

The upper housing portion 838 includes a base plate 842. The base plate 842 includes a body 846 and an extension portion 850. The body 846 can be a generally flat plate with a plate aperture 854 extending therethrough. The extension portion 850 extends away from a side of the body 846. The extension portion 850 can be an arcuate projection extending around the aperture 854. When the upper housing portion 838 is used in the fastener driving tool 10, the outer busing 118D can be omitted. The extension portion 850 can partially define the top surface 34E. The extension portion 850 can additionally or alternatively partially define the channel 46 of the fastener driving tool 10. It should be appreciated that the base plate 842 can provide structural rigidity to the upper housing portion 838. The base plate 842 can be composed of any rigid material including, but not limited to, aluminum and steel.

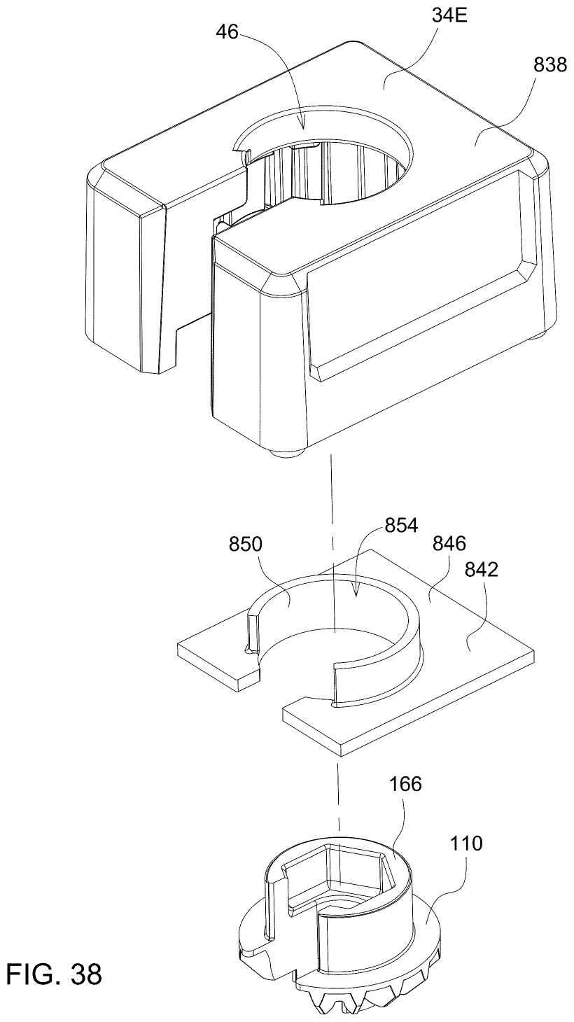

With specific reference to FIG. 38, the second bevel gear 110 can engage the base plate 842. More specifically, the outer extension member 166 of the second bevel gear 110 can extend through the extension portion 850 of the base plate 842.

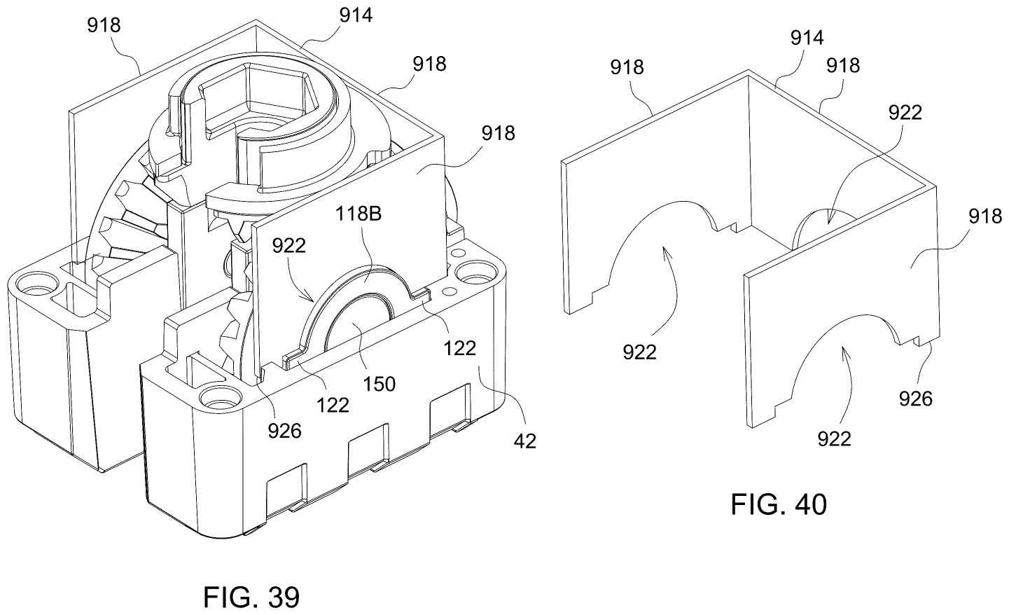

With reference to FIGS. 39 and 40, the fastener driving tool 10 can include a first support bracket 914. The first support bracket 914 is configured to provide structural integrity to the fastener driving tool 10. The first support bracket 914 includes a plurality of sides 918. The illustrated first support bracket 914 includes three sides 918. Each side 918 includes a first cutout 922. Each first cutout 922 extends through a bottom side 926 of the first support bracket 914. The illustrated first cutouts 922 are shaped to engage the respective outer bushings 118A-118C (only 118B shown in FIG. 39). It should be appreciated that one or more of the first cutouts 922 can alternatively be shaped to engage a gear (e.g., the first bevel gear 102 or the intermediate bevel gears 142A, 142B). The first support bracket 914 can engage the upper housing portion 38 to secure the first support bracket 914 within the housing 14 (shown in FIG. 1). The illustrated first support bracket 914 is used with the fastener driving tool 10. It should be appreciated that the first support bracket 914 can be used with any other fastener driving tool described herein.

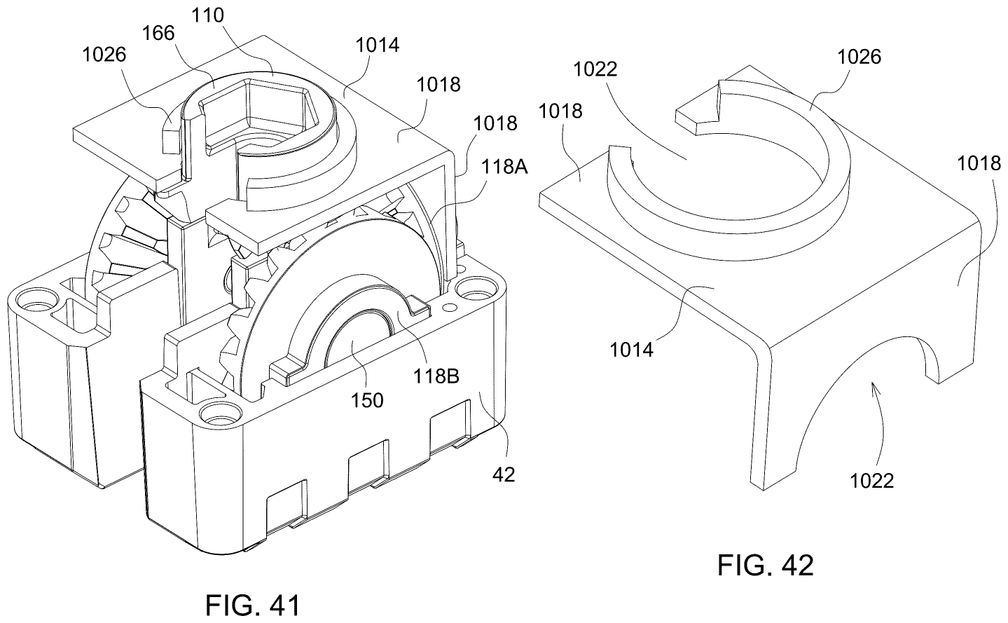

With reference to FIGS. 41 and 42, the fastener driving tool 10 can include a second support bracket 1014. The second support bracket 1014 is configured to provide structural integrity to the fastener driving tool 10. The second support bracket 1014 includes a plurality of sides 1018. The illustrated second support bracket 1014 includes two sides 1018. Each side 1018 includes a second cutout 1022. The two illustrated cutouts 1022 are shaped to engage the outer bushing 118A and the outer extension member 166 of the second bevel gear 110, respectively. The illustrated second support bracket 1014 also includes an extension portion 1026 that receives the outer extension member 166 of the second bevel gear 110. The second support bracket 1014 can engage the upper housing portion 38 to secure the second support bracket 1014 within the housing 14 (shown in FIG. 1). It should be appreciated that one or more of the second cutouts 1022 can alternatively be shaped to engage a different gear (e.g., the first bevel gear 102 or the intermediate bevel gears 142A, 142B) or a different bushing (e.g., the outer bushing 118B, 118C). The illustrated second support bracket 1014 is used with the fastener driving tool 10. It should be appreciated that the second support bracket 1014 can be used with any other fastener driving tool described herein.

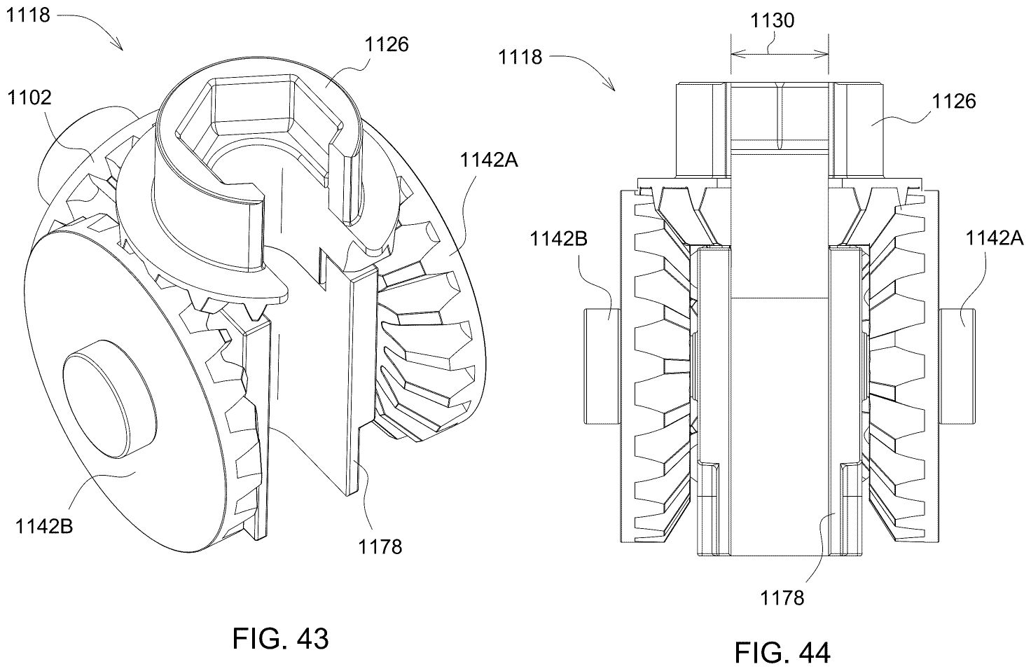

FIGS. 43 and 44 illustrate another embodiment of a transmission assembly 1118 for use in a fastener driving tool (e.g., the fastener driving tool 10). The transmission assembly 1118 is similar to the transmission assembly 18. For brevity, only the differences between the upper transmission assembly 1118 and the transmission assembly 18 are described. Components of the transmission assembly 1118 will be labeled the same as like components of the upper transmission assembly 18 plus a value of 1100. It should be appreciated that the transmission assembly 1118 can include any components described with reference to the transmission assembly 18, and the components can have the same features and function. In addition, alternatives to the components described above with respect to the transmission assembly 18 are also applicable to the transmission assembly 1118.

With reference to FIG. 44, the transmission assembly 1118 includes an output member 1126. The output member 1126 defines a size 1130 (also referred to as a width 1130 or a diameter 1130). The output member 1126 is configured to receive a nut (not shown) associated with the size 1130. The illustrated output member 1126 has a size of 0.5 inches. As such, the output member 1126 is sized to receive a nut having a width or diameter of 0.5 inches. In other embodiments, the output member 1126 can have a different size. For example, the size 1130 can be 0.375 inches, 0.75 inches, or any other size suitable to receive a suitable nut.

Although the invention has been described in detail with reference to certain preferred embodiments, variations and modifications exist within the scope and spirit of one or more independent aspects of the invention as described. Various features and advantages of the invention are set forth in the following claims.

What is claimed is:

1. A fastener driving tool for driving a fastener onto a threaded rod, the fastener driving tool comprising:
a housing;
a tower supported by the housing;
an input member rotatably supported by the tower, the input member defining a first rotational axis;
an output member rotatably supported by the tower, the output member configured to rotatably support the fastener, the output member defining a second rotational axis; and
an intermediate member rotatably supported by the tower and operatively coupled between the input member and the output member, the intermediate member configured to convert an input torque from the input member about the first rotational axis to an output torque about the second rotational axis.

2. The fastener driving tool of claim 1, wherein
the tower includes a plurality of retainers extending into the tower,
the plurality of retainers includes a first retainer and a second retainer,
the input member includes a first projection supported in the first retainer, and
the intermediate member includes a second projection supported in the second retainer.

3. The fastener driving tool of claim 2, further comprising a first bushing supported in the first retainer and a second bushing supported in the second retainer, wherein the first projection is supported in the first bushing, and wherein the second projection is supported in the second bushing.

4. The fastener driving tool of claim 3, wherein
the housing includes a housing notch having a radial cutout,
the fastener driving tool further comprises an outer bushing supported in the housing notch,
the outer bushing includes a lug supported in the radial cutout to inhibit rotation of the outer bushing relative to the housing,
the intermediate member includes an outer projection extending from a side of the intermediate member opposite the second projection, and
the outer projection is supported in the outer bushing.

5. The fastener driving tool of claim 1, wherein the tower includes a plurality of tower shafts extending from sides of the tower, and wherein the plurality of tower shafts includes a first tower shaft and a second tower shaft.

6. The fastener driving tool of claim 5, wherein
the input member includes a first bore,
the intermediate member includes a second bore,
the first tower shaft is received within the first bore, and
the second tower shaft is received within the second bore.

7. The fastener driving tool of claim 6, further comprising a first bearing received in the first bore and a second bearing received in the second bore, wherein the first tower shaft is received within the first bearing, and wherein the second tower shaft is received within the second bearing.

8. The fastener driving tool of claim 1, further comprising a support bracket provided in the housing and extending at least partially around the tower.

9. The fastener driving tool of claim 1, wherein the tower is entirely composed of metal.

10. The fastener driving tool of claim 1, further comprising
a side member operatively coupled between the input member and the intermediate member, and
a reset assembly including
a reset aperture extending into side member,
a pin, and
a biasing member configured to bias the pin away from the reset aperture,
wherein the pin is configured to be moved against the bias of the biasing member and into the reset aperture to inhibit rotation of the intermediate member.

11. A fastener driving tool for driving a fastener onto a threaded rod, the fastener driving tool comprising:
a housing including a lower housing portion and a tower portion extending from the lower housing portion;
a saddle coupled to the tower portion, the saddle and the tower portion defining a plurality of retaining portions therebetween, the plurality of retaining portions including a first retaining portion and a second retaining portion;
an input member rotatably supported by the first retaining portion, the input member defining a first rotational axis;
an output member rotatably supported by the saddle, the output member configured to rotatably support the fastener, the output member defining a second rotational axis; and
an intermediate member rotatably supported by the second retaining portion and operatively coupled between the input member and the output member, the intermediate member configured to convert an input torque from the input member about the first rotational axis to an output torque about the second rotational axis.

12. The fastener driving tool of claim 11, wherein the input member includes a first projection supported in the first retaining portion, and the intermediate member includes a second projection supported in the second retaining portion.

13. The fastener driving tool of claim 12, further comprising a first bushing supported in the first retaining portion and a second bushing supported in the second retaining portion, wherein the first projection is supported in the first bushing, and wherein the second projection is supported in the second bushing.

14. The fastener driving tool of claim 11, wherein
the plurality of retaining portions includes a third retaining portion,
the intermediate member is a first intermediate member, and
the fastener driving tool further comprises a second intermediate member rotatably supported by the third retaining portion and operatively coupled between the input member and the output member, the second intermediate member configured to convert an input torque from the input member about the first rotational axis to an output torque about the second rotational axis.

15. The fastener driving tool of claim 11, wherein the saddle is entirely composed of metal.

16. A fastener driving tool for driving a fastener onto a threaded rod, the fastener driving tool comprising:
a housing;
a tower supported by the housing;
a first shaft rotatably supported by the tower;
a second shaft rotatably supported by the tower;
an input member rotatably supported by the first shaft, the input member defining a first rotational axis;
an output member rotatably supported by the tower, the output member configured to rotatably support the fastener, the output member defining a second rotational axis; and
an intermediate member rotatably supported by the second shaft and operatively coupled between the input member and the output member, the intermediate member configured to convert an input torque from the input member about the first rotational axis to an output torque about the second rotational axis.

17. The fastener driving tool of claim 16, wherein
the tower includes a first shaft bore and a second shaft bore,
the first shaft is supported in the first shaft bore, and
the second shaft is supported in the second shaft bore.

18. The fastener driving tool of claim 17, wherein
the input member includes a first aperture,
the intermediate member includes a second aperture,
the first shaft is supported within the first aperture, and
the second shaft is supported within the second aperture.

19. The fastener driving tool of claim 18, further comprising a first bearing supported within the first aperture and a second bearing supported in the second aperture, wherein the first shaft is supported in the first bearing, and wherein the second shaft is supported in the second bearing.

20. The fastener driving tool of claim 16, further comprising a third shaft rotatably supported by the tower, wherein the intermediate member is a first intermediate member, and wherein the fastener driving tool further comprises a second intermediate member rotatably supported by the third shaft and operatively coupled between the input member and the output member, the second intermediate member also configured to convert the input torque from the input member about the first rotational axis to the output torque about the second rotational axis.
